(19) United States
(12) Patent Application Publication
(10) Pub. No.: US 2023/0133174 A1
(43) Pub. Date: May 4, 2023

(54) SYSTEMS, METHODS, AND MEDIA FOR MORE EFFICIENT PERIDYNAMIC MODELING OF BOUNDED DOMAINS

(71) Applicant: BOARD OF REGENTS OF THE UNIVERSITY OF NEBRASKA, Lincoln, NE (US)

(72) Inventors: Siavash Jafarzadeh, Lincoln, NE (US); Florin Bobaru, Lincoln, NE (US); Adam Larios, Lincoln, NE (US)

(21) Appl. No.: 17/883,195

(22) Filed: Aug. 8, 2022

Related U.S. Application Data
(60) Provisional application No. 63/230,402, filed on Aug. 6, 2021.

(51) Int. Cl. G06F 30/20; G06F 17/14

(52) U.S. Cl. CPC G06F 30/20; G06F 17/141; G06F 2111/10

(57) ABSTRACT

In accordance with some embodiments, systems, methods, and media for efficient peridynamic modeling with bounded domains are provided. In some embodiments, a method comprises: receiving a plurality of parameters associated with a non-local model that has a convolutional structure to be used for one or more simulations, wherein the plurality of parameters includes a shape of a domain Ω, a horizon size δ, and one or more boundary constraints; drawing a periodic box [symbol] that includes the domain Ω and a boundary layer Γ extending from the domain Ω; imposing the one or more boundary constraints on the boundary layer Γ; performing a simulation of a physical process using the non-local model and convolutional properties of Fourier transforms; and causing a result of the simulation to be presented.

### CROSS-REFERENCE TO RELATED APPLICATIONS

This application is based on, claims the benefit of, and claims priority to U.S. Provisional Application No. 63/230,402, filed Aug. 6, 2021, which is hereby incorporated herein by reference in its entirety for all purposes.

### STATEMENT REGARDING FEDERALLY SPONSORED RESEARCH

This invention was made with government support under CMMI1953346 awarded by the National Science Foundation. The government has certain rights in the invention.

### BACKGROUND

Peridynamics (sometimes referred to herein as PD) is a nonlocal extension of classical continuum mechanics that has been used in modelling of fracture and damage. In contrast with classical (i.e., local) models described using spatial derivatives, governing equations in PD can replace spatial derivatives with integral operators. For example, in lieu of partial differential equations used in classical models, PD can use integro-differential equations. In PD, nonlocal interactions can be considered between points within a certain distance, replacing the usual spatial derivatives with integral operators. This can eliminate the usual requirements of continuity and smoothness for problem's solution function (e.g., displacement field), allowing the emergence and evolution of discontinuities, such as cracks and damage, to be modeled using PD as natural parts of the solution to the governing equations. However, numerical solutions to such nonlocal formulations are relatively expensive, due in part to the computation of volume integrals (or area integrals in 2D) performed at each node.

Nonlocal diffusion-type equations are frequently used to describe various phenomena such as swarm of organisms, flocking of birds, pedestrian traffic, delayed reaction-diffusion in biology, material dissolution and corrosion, etc. A peridynamic diffusion equation has been used a nonlocal formulation for modeling diffusion in domains with evolving discontinuities, such as heat diffusion in a cracking domain or mass-transfer in corrosion damage propagation.

Meshfree techniques based on one-point Gaussian quadrature are perhaps the most widely used numerical method for discretizing PD equations due to its benefits in modeling damage and fracture. Continuous and discontinuous Galerkin finite element methods (FEM) are other approaches used for discretizing PD equations. Continuous FEM models for PD formulations are rarely used in simulating fracture, while the discontinuous Galerkin-based discretizations of PD models have shown some difficulties in correctly predicting dynamic brittle fracture. When these discretization techniques are used, nonlocality increases the cost for a PD model, relative to the cost of numerically approximating local models. For a certain size of the nonlocal interaction region (sometimes referred to as the “horizon” size), the computational complexity of the meshfree and FEM approaches is O(N²) with N being the total number of nodes employed to discretize the domain. Thus, for largescale problems in 3D, the cost becomes prohibitive, even on massively parallel computers.

Various attempts have been made to reduce the cost of peridynamic simulations. For example, coupling the local theory with PD is one approach that uses a local model for parts of the domain, and uses the PD model only at locations near cracks/damage. This approach does not work well for problems in which damage/cracks are (or become) widely distributed throughout the domain, such as in problems like impact fragmentation, etc.

Accordingly, new systems, methods, and media for efficient peridynamic modeling with bounded domains are desirable.

### SUMMARY

In accordance with some embodiments of the disclosed subject matter, systems, methods, and media for efficient peridynamic modeling with bounded domains are provided.

In accordance with some embodiments of the disclosed subject matter, a method is provided, comprising receiving a plurality of parameters associated with a non-local model that has a convolutional structure to be used for one or more simulations, wherein the plurality of parameters includes a shape of a domain Ω, a horizon size δ, and one or more boundary constraints; drawing a periodic box [symbol] that includes the domain Ω and a boundary layer Γ extending from the domain Ω; imposing the one or more boundary constraints on the boundary layer Γ; performing a simulation of a physical process using the non-local model and convolutional properties of Fourier transforms; and causing a result of the simulation to be presented.

In some embodiments, the non-local model comprises a peridynamic model.

In some embodiments, the plurality of parameters includes one or more initial conditions.

In some embodiments, performing the simulation comprises: discretizing the non-local model using one or more Fourier transforms, wherein integral operators associated with the model are expressed in terms of convolutions; and solving the discretized non-local model on T.

In some embodiments, the non-local model comprises a model of diffusion.

In some embodiments, the model of diffusion is non-linear.

In some embodiments, the non-local model comprises a model of deformation and fracture.

In some embodiments, the model of deformation and fracture is non-linear.

In some embodiments, the non-local model comprises a model of dissolution damage.

In some embodiments, the non-local model comprises a model of corrosion damage.

In some embodiments, the domain Ω comprises a three-dimensional (3D) shape.

In some embodiments, the time step size satisfies a constraint.

In some embodiments, the time step size Δ t satisfies Δt≤1/vβ, where v is a scalar diffusivity constant associated with the non-local model, and β corresponds to an integral of a kernel function associated with the non-local model over a region H_0 of the domain Ω, H_0 having a size based on the horizon size δ and the dimensionality of the domain Ω.

In some embodiments, causing the result of the simulation to be presented comprises: causing a visual representation of at least a portion of the non-local model at a particular time step to be presented.

In some embodiments, causing the result of the simulation to be presented comprises: causing a visual state of at least a portion of the non-local model at a particular load step to be presented.

In some embodiments, receiving the plurality of parameters associated with the peridynamic model to be simulated, comprises: receiving the plurality of parameters from a remote computing device over a wide area network (WAN).

In accordance with some embodiments of the disclosed subject matter, a system for peridynamic modeling is provided, the system comprising: at least one processor that is configured to: receive a plurality of parameters associated with a non-local model that has a convolutional structure to be used for one or more simulations, wherein the plurality of parameters includes a shape of a domain Ω, a horizon size δ, and one or more boundary constraints; draw a periodic box T that includes the domain Ω and a boundary layer Γ extending from the domain Ω; impose the one or more boundary constraints on the boundary layer Γ; perform a simulation of a physical process using the non-local model and convolutional properties of Fourier transforms; and cause a result of the simulation to be presented.

In accordance with some embodiments of the disclosed subject matter, a non-transitory computer readable medium containing computer executable instructions that, when executed by a processor, cause the processor to perform a method for peridynamic modeling is provided, the method comprising: receiving a plurality of parameters associated with a non-local model that has a convolutional structure to be used for one or more simulations, including a shape of a domain Ω, a horizon size δ, and one or more boundary constraints; drawing a periodic box T that includes the domain Ω and a boundary layer Γ extending from the domain Ω; imposing the one or more boundary constraints on the boundary layer Γ; performing a simulation of a physical process using the non-local model and convolutional properties of Fourier transforms; and causing a result of the simulation to be presented.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various objects, features, and advantages of the disclosed subject matter can be more fully appreciated with reference to the following detailed description of the disclosed subject matter when considered in connection with the following drawings, in which like reference numerals identify like elements.

FIG. 1 shows an example of a system for efficient peridynamic modeling with bounded domains in accordance with some embodiments of the disclosed subject matter.

FIG. 2 shows an example of hardware that can be used to implement a computing device and a server, shown in FIG. 1 in accordance with some embodiments of the disclosed subject matter.

FIG. 3 shows an example of a peridynamic body and a horizon of a generic point in the body.

FIG. 4 shows an example of a peridynamic domain and an associated boundary layer that can be used in connection with efficient peridynamic modeling of transient diffusion in accordance with some embodiments of the disclosed subject matter.

FIG. 5 shows an example of the peridynamic domain of FIG. 4 surrounded by a periodic box that can be used to extend the bounded-domain peridynamic model into a periodic domain in accordance with some embodiments of the disclosed subject matter.

FIG. 6 shows an example of a process for efficient peridynamic modeling with bounded domains in accordance with some embodiments of the disclosed subject matter.

FIG. 7 shows examples comparing numerical solutions to a 1D nonlocal diffusion problem with two Dirichlet (non-periodic) boundary conditions determined using mechanisms described herein and the exact solution for the problem at various times.

FIG. 8 shows example convergence studies in terms of spatial resolution for three time step sizes based on results determined using mechanisms described herein and results determined using another technique.

FIG. 9 shows an example convergence study in terms of spatial resolution based on results determined using mechanisms described herein for a 1D diffusion example with non-periodic boundary conditions.

FIG. 10 shows examples of computational complexity of a meshfree technique and techniques described herein for solving a 1D diffusion example with non-periodic boundary conditions.

FIG. 11 shows examples of numerical solutions of a 2D nonlinear volume-constrained peridynamic transient diffusion problem determined using mechanisms described herein for efficient peridynamic modeling with bounded domains.

FIG. 12 shows examples of convergence studies in terms of spatial and temporal resolutions for the nonlinear 2D volume-constrained peridynamic transient diffusion problem determined using mechanisms described herein for efficient peridynamic modeling with bounded domains.

FIG. 13 shows example schematics of a cube with an insulated cut-out, and an extended domain with nonlocal boundary layers for imposing boundary conditions using mechanisms described herein for efficient peridynamic modeling with bounded domains.

FIG. 14 shows examples of 3D peridynamic diffusion simulation results for a cube with an insulated cutout determined using mechanisms described herein for efficient peridynamic modeling with bounded domains.

FIG. 15 shows examples comparing the 3D solution in a cross-section determined using mechanisms described herein for efficient peridynamic modeling with bounded domains, and results generated using conventional techniques.

FIG. 16 shows examples of efficiency gains relative to m-factor values for the 3D solution determined using mechanisms described herein for efficient peridynamic modeling with bounded domains over the meshfree technique, and the speedup versus problem size (N) using mechanisms described with parallel fast Fourier transform solvers.

### DETAILED DESCRIPTION

In accordance with various embodiments, mechanisms (which can, for example, include systems, methods, and media) for efficient peridynamic modeling with bounded domains are provided.

Reducing the computational cost for PD models can be achieved with Fourier-based techniques. For example, the PD operator in the PD diffusion equation can be expressed in terms of convolution integrals. Fourier-based techniques can be used to transform the convolution integral operator into a multiplication in the Fourier space. Such techniques can have a complexity of O(N log₂ N), with the bulk of the computations used to compute the Fourier transform and its inverse (e.g., via fast Fourier transform (FFT)). However, Fourier-based techniques are normally only useable in periodic domains, limiting the use of such techniques to a small subset of problems to which PD can be applied.

For example, Fourier-based techniques can be used to solve the nonlocal Allen-Cahn equation, fractional-in-space reaction diffusion, and PD diffusion and wave equations with linear operators, over periodic domains. A certain class of PD models discretized with the FEM or meshfree approaches, are amenable to fast solutions using a Fourier-based approach.

As another example, Fourier-based techniques can be applied to certain non-periodic domains and arbitrary boundary conditions using a boundary adapted spectral method (BASM), which can also be referred to as a fast convolution-based method (FCBM) for 1D linear peridynamic diffusion problems, using a volume penalization (VP) technique. However, while such an approach can produce significant efficiency gains compared with meshfree discretization for PD diffusion in 1D, it was limited to 1D and linear problems.

In some embodiments, mechanisms described herein can utilize an embedded constraint(s) that can facilitate use of Fourier-based techniques for diffusion problems in multiple dimensions (e.g., in 2D and 3D problems), and in nonlinear PD diffusion problems. Note that mechanisms described herein can also be applied to problems with linear PD diffusion. Additionally, in some embodiments, mechanisms described herein can utilize an embedded constrain(s) that can facilitate enforcement of boundary conditions and use of Fourier-based techniques for at least elastic (linear or nonlinear) deformations, fracture and damage, corrosion, and dissolution.

In some embodiments, mechanisms described herein can be used to generate constitutive models and material models with convolutional structures that can facilitate efficient peridynamic modeling with bounded domains for a variety of problems. Additionally, mechanisms described herein can configure nonlinear problems, such as non-linear deformation, corrosion damage, and fracture (e.g., dynamic fracture in a brittle material), as a convolution structure amenable to modeling using techniques described herein. Note that mechanisms described herein can also be applied to classical local models. For example, mechanisms described herein can be used with the PD correspondence model that places the classical local model into a peridynamic framework.

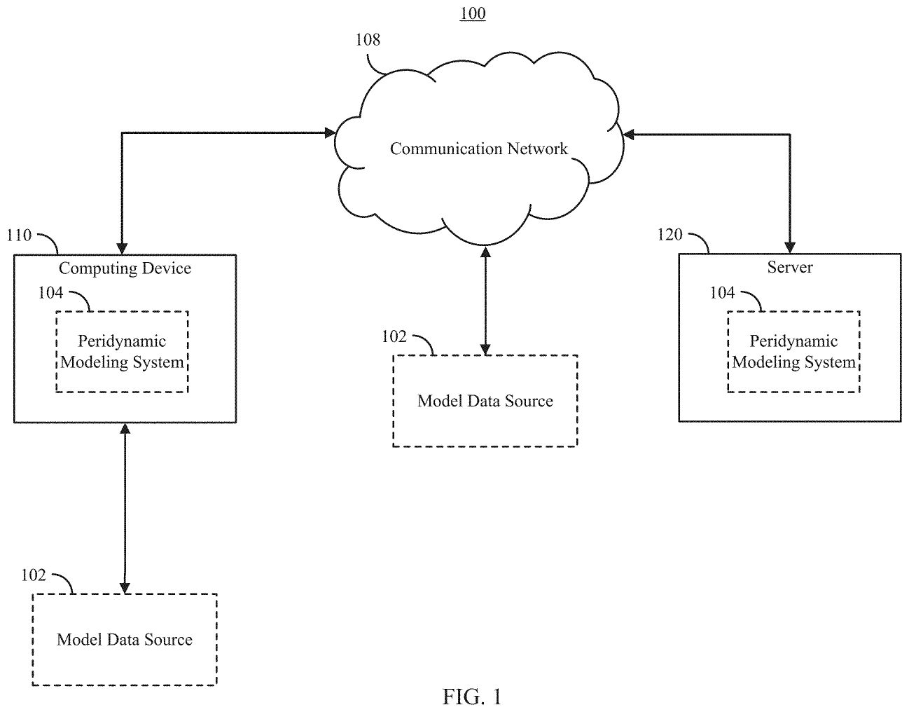

FIG. 1 shows an example 100 of a system for efficient peridynamic modeling with bounded domains in accordance with some embodiments of the disclosed subject matter. As shown in FIG. 1, a computing device 110 can receive model data from a model data source 102. In some embodiments, computing device 110 can execute at least a portion of a peridynamic modeling system 104 to simulate a problem (e.g., a diffusion problem, a fracture problem, a deformation problem, a corrosion problem, an erosion problem, an electrostatics problem, etc.) using peridynamic modeling techniques.

In some embodiments, computing device 110 can execute at least a portion of peridynamic modeling system 104 to efficiently (e.g., more quickly, using less computational resources, etc.) simulating a problem with bounded or periodic domains and linear or non-linear behavior using mechanisms described herein.

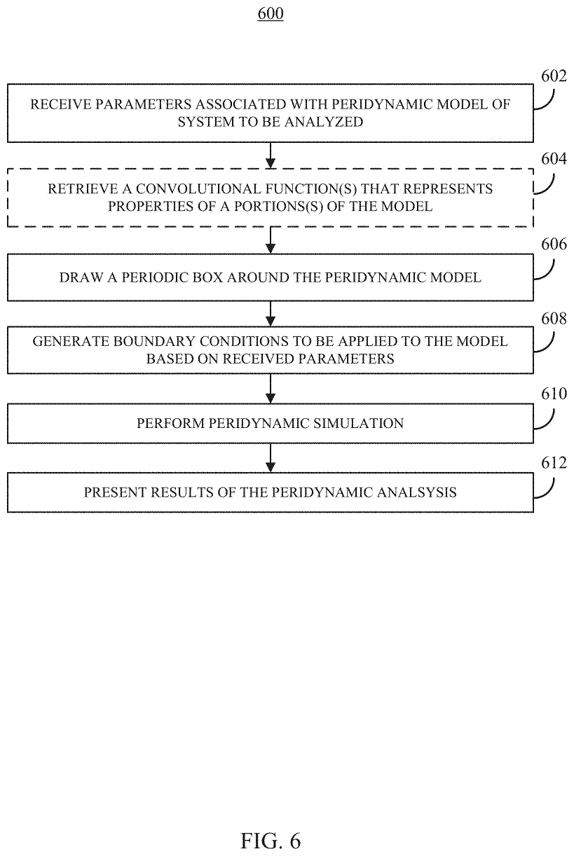

Additionally or alternatively, in some embodiments, computing device 110 can communicate data received from model data source 102 to a server 120 over a communication network 108, which can execute at least a portion of peridynamic modeling system 104. In such embodiments, server 120 can return information to computing device 110 (and/or any other suitable computing device) indicative of an output of a peridynamic modeling process. In some embodiments, peridynamic modeling system 104 can execute one or more portions of process 600 described below in connection with FIG. 6.

In some embodiments, computing device 110 and/or server 120 can be any suitable computing device or combination of devices, such as a desktop computer, a laptop computer, a smartphone, a tablet computer, a wearable computer, a server computer, a virtual machine being executed by a physical computing device, etc.

In some embodiments, model data source 102 can be any suitable source of model data (e.g., data related to one or more materials that can be used to perform peridynamic modeling, data related to one or more bodies that be used to perform peridynamic modeling) and/or other data that can be used to simulate a problem. In a more particular example, model data source 102 can include memory storing modeling data (e.g., local memory of computing device 110, local memory of server 120, cloud storage, portable memory connected to computing device 110, portable memory connected to server 120, etc.). In another more particular example, model data source 102 can include an application configured to generate model data (e.g., computer-aided design (CAD) software) being executed by computing device 110, server 120, and/or any other suitable computing device.

In some embodiments, model data source 102 can be local to computing device 110. For example, model data source 102 can be incorporated with computing device 110 (e.g., computing device 110 can include memory that stores model data, and/or can execute a program that generates model data). As another example, model data source 102 can be connected to computing device 110 by a cable, a direct wireless link, etc. Additionally or alternatively, in some embodiments, model data source 102 can be located locally and/or remotely from computing device 110, and can communicate model data to computing device 110 (and/or server 120) via a communication network (e.g., communication network 108).

In some embodiments, communication network 108 can be any suitable communication network or combination of communication networks. For example, communication network 108 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE, LTE Advanced, NR, etc.), a wired network, etc. In some embodiments, communication network 108 can be a local area network (LAN), a wide area network (WAN), a public network (e.g., the Internet), a private or semi-private network (e.g., a corporate or university intranet), any other suitable type of network, or any suitable combination of networks. Communications links shown in FIG. 1 can each be any suitable communications link or combination of communications links, such as wired links, fiber optic links, Wi-Fi links, Bluetooth links, cellular links, etc.

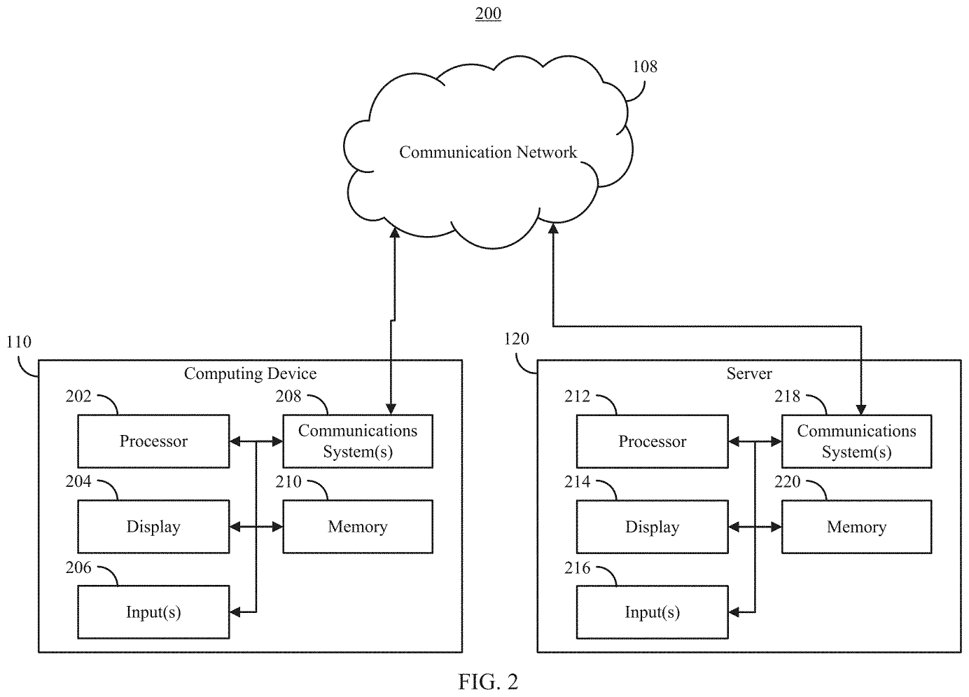

FIG. 2 shows an example 200 of hardware that can be used to implement computing device 110 and/or server 120 in accordance with some embodiments of the disclosed subject matter. As shown in FIG. 2, in some embodiments, computing device 110 can include a processor 202, a display 204, one or more inputs 206, one or more communication systems 208, and/or memory 210. In some embodiments, processor 202 can be any suitable hardware processor or combination of processors, such as a central processing unit (CPU), a graphics processing unit (GPU), an application specific integrated circuit (ASIC), a field-programmable gate array (FPGA), etc. In some embodiments, display 204 can include any suitable display devices, such as a computer monitor, a touchscreen, a television, etc. In some embodiments, inputs 206 can include any suitable input devices and/or sensors that can be used to receive user input, such as a keyboard, a mouse, a touchscreen, a microphone, etc.

In some embodiments, communications systems 208 can include any suitable hardware, firmware, and/or software for communicating information over communication network 108 and/or any other suitable communication networks. For example, communications systems 208 can include one or more transceivers, one or more communication chips and/or chip sets, etc. In a more particular example, communications systems 208 can include hardware, firmware and/or software that can be used to establish a Wi-Fi connection, a Bluetooth connection, a cellular connection, an Ethernet connection, etc.

In some embodiments, memory 210 can include any suitable storage device or devices that can be used to store instructions, values, etc., that can be used, for example, by processor 202 to perform a computer vision task, to present content using display 204, to communicate with server 120 via communications system(s) 208, etc. Memory 210 can include any suitable volatile memory, non-volatile memory, storage, or any suitable combination thereof. For example, memory 210 can include random access memory (RAM), read-only memory (ROM), electronically-erasable programmable read-only memory (EEPROM), one or more flash drives, one or more hard disks, one or more solid state drives, one or more optical drives, etc. In some embodiments, memory 210 can have encoded thereon a computer program for controlling operation of computing device 110. For example, in such embodiments, processor 202 can execute at least a portion of the computer program to transmit model data to server 120, receive model data from server 120, efficiently simulate a physical process (e.g., diffusion, fracture, etc.), generate results related to the simulation, receive results related to the simulation from server 120, and/or present results related to the simulation. As another example, processor 202 can execute at least a portion of the computer program to implement peridynamic modeling system 104. As yet another example, processor 202 can execute at least a portion of process 600 described below in connection with FIG. 6.

In some embodiments, server 120 can include a processor 212, a display 214, one or more inputs 216, one or more communications systems 218, and/or memory 220. In some embodiments, processor 212 can be any suitable hardware processor or combination of processors, such as a CPU, a GPU, an ASIC, an FPGA, etc. In some embodiments, display 214 can include any suitable display devices, such as a computer monitor, a touchscreen, a television, etc. In some embodiments, inputs 216 can include any suitable input devices and/or sensors that can be used to receive user input, such as a keyboard, a mouse, a touchscreen, a microphone, etc.

In some embodiments, communications systems 218 can include any suitable hardware, firmware, and/or software for communicating information over communication network 108 and/or any other suitable communication networks. For example, communications systems 218 can include one or more transceivers, one or more communication chips and/or chip sets, etc. In a more particular example, communications systems 218 can include hardware, firmware and/or software that can be used to establish a Wi-Fi connection, a Bluetooth connection, a cellular connection, an Ethernet connection, etc.

In some embodiments, memory 220 can include any suitable storage device or devices that can be used to store instructions, values, etc., that can be used, for example, by processor 212 to present content using display 214, to communicate with one or more computing devices 110, etc. Memory 220 can include any suitable volatile memory, non-volatile memory, storage, or any suitable combination thereof. For example, memory 220 can include RAM, ROM, EEPROM, one or more flash drives, one or more hard disks, one or more solid state drives, one or more optical drives, etc. In some embodiments, memory 220 can have encoded thereon a server program for controlling operation of server 120. For example, in such embodiments, processor 212 can receive model data from computing device 110, transmit model data to computing device 110, efficiently simulate a physical process (e.g., diffusion, fracture, etc.), generate results related to the simulation, transmit results related to the simulation to computing device 110, and/or cause results related to the simulation to be presented (e.g., by computing device 110). As another example, processor 212 can execute at least a portion of the computer program to implement peridynamic modeling system 104. As yet another example, processor 212 can execute at least a portion of process 600 described below in connection with FIG. 6.

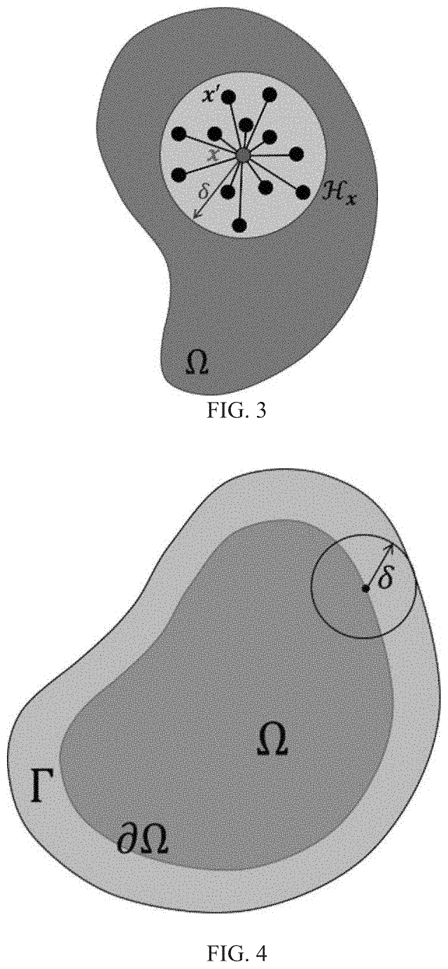

FIG. 3 shows an example of a peridynamic body and a horizon of a generic point in the body. In peridynamics, the peridynamic body can be specified as a domain Ω, and a spatial point within the domain Ω can be specified by a position vector x∈ [symbol] ³ (e.g., when domain Ω is specified in 3D). The spatial point x can interact with other points within a finite size region (sometimes referred to herein as a “neighborhood”) centered at X. Such a region can be any suitable shape, such as a disk in 2D, or a sphere in 3D. This neighborhood can referred to as a horizon region of x, which can be specified as [symbol] ₓ, and the radius of the neighborhood can be referred to as the horizon size, or simply, the horizon, and can be specified as δ. Points located inside [symbol] ₓ can be denoted by x′ and can be referred to as the family of x. FIG. 3 schematically shows a peridynamic body with a generic point x, its family and its horizon. Objects that carry pairwise nonlocal interactions between x and x′ can be referred to as bonds. A bond vector for each family pair can be specified as=x′−x. In general, plain (i.e., non-bold) italic letters denote scalars, boldface italic letters denote vectors, and boldface non-italic letters denote tensors. Peridynamic states, described below, are denoted by underlined letters.

FIG. 4 shows an example of a peridynamic domain and an associated boundary layer that can be used in connection with efficient peridynamic modeling of transient diffusion in accordance with some embodiments of the disclosed subject matter.

The general nonlinear anisotropic inhomogeneous case of the classical diffusion equation can be expressed as:

$$\frac{\partial u ( x , t )}{\partial t} = ∇ \cdot [ C ( x , t ) \cdot ∇ u ( x , t ) ] + r ( x , t ) \qquad ( 1 )$$

where u(x,t) is a function describing the diffusing quantity (e.g., concentration in mass transport, temperature in heat transfer, etc.) at point X and time t, r is a source term, ∇ is the gradient operator, the symbol (⋅) denotes inner (dot) product, and C is the second-order diffusivity tensor, which may depend on position and/or time. Nonlinearity in EQ. (1) can arise if C depends on u (e.g., concentration-dependent diffusivity, or temperature-dependent conductivity). If C is independent of u the equation is linear. In this case, for an isotropic and homogenous diffusion defined by ∇ as the scalar diffusivity constant, EQ. (1) can become:

$$\frac{\partial u ( x , t )}{\partial t} = ν {∇}^{2} u ( x , t ) + r ( x , t ) , \qquad ( 2 )$$

where ∇² denotes the classical Laplacian operator.

A general PD diffusion equation can be expressed as a nonlocal version of EQ. (1):

$$\frac{\partial u ( x , t )}{\partial t} = {ℒ}_{γ} u ( x , t ) + r ( x , t ) , \qquad ( 3 )$$

where the classical diffusion operator ∇·(C·∇) in EQ. (1) can be replaced with the PD diffusion operator [symbol] _{γ}:

$${ℒ}_{γ} u ( x , t ) = γ ( x , {x}^{′} , t ) [ u ( {x}^{′} , t ) - u ( x , t ) ] {dx}^{′} . \qquad ( 4 )$$

In EQ. (4), the kernel γ can be assumed to be nonnegative and symmetric in the first two variables: γ(x,x′,t)=γ(x′,x,t). Kernel γ can define the nonlocal interaction between X and X′. PD diffusion can be nonlinear if γ depends on u(x,t) and/or u(x′,t), and otherwise can be linear.

For isotropic homogeneous diffusion with constant diffusivity, the peridynamic diffusion equation can be expressed as:

$$\frac{\partial u ( x , t )}{\partial t} = {νℒ}_{μ} u ( x , t ) + r ( x , t ) , \qquad ( 5 )$$

where [symbol] _{μ} is the PD Laplacian operator, a nonlocal version of the Laplacian in EQ. (2). The PD Laplacian can be expressed as:

$${ℒ}_{μ} u ( x , t ) = μ ( {x}^{′} - x ) [ u ( {x}^{′} , t ) - u ( x , t ) ] {dx}^{′} , \qquad ( 6 )$$

where a kernel function μ is nonnegative and symmetric (e.g., μ(x)=μ(−x)).

In order to take advantage of increased efficiency facilitated by Fourier-based techniques for solving PD diffusion problems, the PD operator can be expressed in terms of convolutions. For example, the PD Laplacian given in EQ. (6) can be decomposed into a convolution integral term and a linear term:

$${ℒ}_{μ} u ( x , t ) = μ ( x - {x}^{′} ) u ( {x}^{′} , t ) {dx}^{′} - ( μ ( {x}^{′} - x ) {dx}^{′} ) u ( x , t ) , \qquad ( 7 )$$

Additionally, since μ(x-x′) is zero outside of [symbol] ₓ, EQ. (7) can be rewritten to:

[symbol]

_{μ}u(x,t)=[μ*u](x,t)−βu(x,t) (8)

where (*) denotes the convolution operator,

$$[ μ * u ] ( x , t ) = μ ( x - {x}^{′} ) u ( {x}^{′} , t ) {dx}^{′} , \qquad ( 9 )$$

$$and :$$

$$β = μ ( x ) dx . \qquad ( 10 )$$

Note that for examples other than this linear case, a similar decomposition can be performed for certain classes of nonlinear problems for which such convolutional expressions exist. For example, for kernels of the form:

γ(x,x′,t)=σ(x,x′,u,u′,t)ω(x′−x,t) (11)

with Ω(X′x,t)=Ω(x−x′,t),σ(x,x′,u,u′,t)=σ(x′,x,u′,u,t) and σ being a linear combination of functions (or products of such functions) that depend on (x,u,t) or (x′,u′,t). The decomposition into convolutions for a specific example of such PD nonlinear diffusion operators is described below in connection with EQ. (12).

If the kernel γ in EQ. (4) is defined as:

$$γ ( x , {x}^{′} , t ) = [ \frac{f ( x , u , t ) h ( {x}^{′} , {u}^{′} , t ) + f ( {x}^{′} , {u}^{′} , t ) h ( x , u , t )}{2} ] ω ( {x}^{′} - x , t ) \qquad ( 12 )$$

where u′ denotes u(x′,t) for notation simplicity. Similarly, by denoting f′ and h′ for f(x′,u′,t) and h(x′,u′,t) respectively, the nonlinear diffusion PD operator becomes:

$${ℒ}_{γ} u ( x , t ) = \{ [ \frac{f ( x , u , t ) h ( {x}^{′} , {u}^{′} , t ) + f ( {x}^{′} , {u}^{′} , t ) h ( x , u , t )}{2} ] ω ( {x}^{′} - x , t ) \} [ u ( {x}^{′} , t ) - u ( x , t ) ] {dx}^{′} = \frac{1}{2} ( {fh}^{′} + {f}^{′} h ) ω ( x - {x}^{′} , t ) ( {u}^{′} - u ) {dx}^{′} = \frac{1}{2} ( {fh}^{′} {u}^{′} - {fh}^{′} u + {f}^{′} {hu}^{′} - {f}^{′} hu ) ω ( x - {x}^{′} , t ) {dx}^{′} = \frac{1}{2} [ {fh}^{′} {u}^{′} ω ( x - {x}^{′} , t ) {dx}^{′} - {fh}^{′} u ω ( x - {x}^{′} , t ) {dx}^{′} + {f}^{′} {hu}^{′} ω ( x - {x}^{′} , t ) {dx}^{′} - {f}^{′} hu ω ( x - {x}^{′} , t ) {dx}^{′} ] = \frac{1}{2} [ f {h}^{′} {u}^{′} ω ( x - {x}^{′} , t ) {dx}^{′} - fu {h}^{′} ω ( x - {x}^{′} , t ) {dx}^{′} + h {f}^{′} {u}^{′} ω ( x - {x}^{′} , t ) {dx}^{′} - hu {f}^{′} ω ( x - {x}^{′} , t ) {dx}^{′} ] = \frac{1}{2} \{ f [ ω * ( hu ) ] - fu ( ω * h ) + h [ ω * ( fu ) ] - hu ( ω * f ) \} \qquad ( 13 )$$

Note that EQ. (8), the linear case, can be recovered from EQ. (13) when f=h=1, and Ω=μ.

In some embodiments, mechanisms described herein can be generalized and can be applied to any integral operator with a convolutional structure. For example, as described in Appendix D, which is hereby incorporated by reference herein, mechanisms described herein can be applied to PD equations of motion (e.g., to model deformation, damage, fracture, etc.). Mechanisms described herein can be used with models that are elastic or inelastic, linear or non-linear, and dynamic or static. As another example, as described in Appendix E, which is hereby incorporated by reference herein, mechanisms described herein can be applied to dissolution problems and corrosion damage problems.

In connection with EQS. (14) to (34), the convolution form given in EQ. (8) for the linear case and in EQ. (13) for the non-linear case are used to describe a Fourier-based technique for peridynamic models of diffusion in 3D periodic domains. As described in Appendix D, similar techniques can be used to apply a Fourier-based technique for peridynamic models of deformation and/or fracture (e.g., based on peridynamic equations of motion).

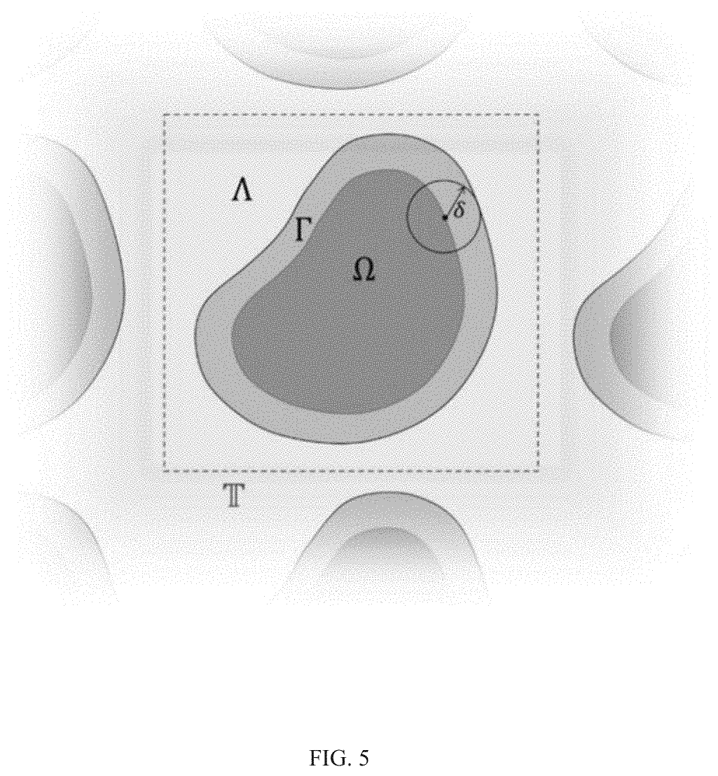

As described above, EQ. (5) expresses the peridynamic diffusion equation for isotropic homogeneous PD diffusion. In order to apply Fourier-based techniques, mechanisms described herein can assume periodicity of the 3D domain in the Cartesian directions. If u(x,t) is a complex-valued scalar function defined over the periodic domain [symbol] =[0, L₁]×[0, L₂]×[0, L₃], 0 can be identified with L₁, L₂, and L₃ in all three directions to create the assumed domain periodicity (techniques that can be used to extend this to arbitrary domains are described below in connection with FIG. 5). Then u(x,t) can be expressed using the following infinite Fourier series in space:

$$u ( x , t ) = {\sum }_{{k}_{3} = - ∞}^{+ ∞} {\sum }_{{k}_{2} = - ∞}^{+ ∞} {\sum }_{{k}_{1} = - ∞}^{+ ∞} \hat{u} ( k , t ) {e}^{2 πζ ( \frac{{k}_{1} {x}_{1}}{{L}_{1}} + \frac{{k}_{2} {x}_{2}}{{L}_{2}} + \frac{{k}_{3} {x}_{3}}{{L}_{3}} )} \qquad ( 14 )$$

where k={k₁,k₂,k₃} is the integer vector of Fourier modes, ζ=\sqrt{−1}, and:

$$\hat{u} ( k , t ) = \frac{1}{{L}_{3} {L}_{2} {L}_{1}} {\int }_{0}^{{L}_{3}} {\int }_{0}^{{L}_{2}} {\int }_{0}^{{L}_{1}} u ( x , t ) {e}^{- 2 πζ ( \frac{{k}_{1} {x}_{1}}{{L}_{1}} + \frac{{k}_{2} {x}_{2}}{{L}_{2}} + \frac{{k}_{3} {x}_{3}}{{L}_{3}} )} {dx}_{1} {dx}_{2} {dx}_{3} \qquad ( 15 )$$

are the Fourier coefficients of U for different values of k. EQ. (15) can also be referred to as the Fourier transform of u while EQ. (14) can be referred to as the inverse Fourier transform of û. The kernel function μ (see EQ. (6)) can also be expressed using a similar Fourier series if it is assumed to be a periodic complex-valued scalar function defined over [symbol] :

$$μ ( x ) = {\sum }_{{k}_{3} = - ∞}^{+ ∞} {\sum }_{{k}_{2} = - ∞}^{+ ∞} {\sum }_{{k}_{1} = - ∞}^{+ ∞} \hat{μ} ( k ) {e}^{2 πζ ( \frac{{k}_{1} {x}_{1}}{{L}_{1}} + \frac{{k}_{2} {x}_{2}}{{L}_{2}} + \frac{{k}_{3} {x}_{3}}{{L}_{3}} )} , and \qquad ( 16 )$$

$$\hat{μ} ( k ) = \frac{1}{{L}_{3} {L}_{2} {L}_{1}} {\int }_{0}^{{L}_{3}} {\int }_{0}^{{L}_{2}} {\int }_{0}^{{L}_{1}} μ ( x ) {e}^{- 2 πζ ( \frac{{k}_{1} {x}_{1}}{{L}_{1}} + \frac{{k}_{2} {x}_{2}}{{L}_{2}} + \frac{{k}_{3} {x}_{3}}{{L}_{3}} )} {dx}_{1} {dx}_{2} {dx}_{3} \qquad ( 17 )$$

In this case, the PD Laplacian operator of u becomes:

[symbol]

_{μ}u(x,t)=[μ [symbol] u](x,t)−βu(x,t) (18)

Where ( [symbol] ) denotes the 3D circular (sometimes referred to as cyclic or periodic) convolution on [symbol] :

[μ [symbol] u](x,t)= [symbol] u(x−x′)u(x′,t)dx′ (19)

In the Fourier space, the circular convolution is transformed into multiplication of the convoluted functions:

[symbol]

{[μ [symbol] u](x,t)}=L₃L₂L₁ [symbol] (μ) [symbol] (u)=L₃L₂L₁\hat{μ}(k)û(k,t) (20)

where [symbol] denotes the Fourier transform operation.

Using the Discrete Fourier Transform (DFT) can facilitate simulation of a problem using mechanisms described herein. Accordingly, u and μ can be approximated using truncated (finite) Fourier series. For example, if N₁, N₂, and N₃ are three integer numbers up to which the Fourier series are truncated in the three directions, then the truncated Fourier series can be represented as:

$${u}^{N} ( x , t ) = {\sum }_{{k}_{3} = - {N}_{3} / 2}^{+ {N}_{3} / 2} {\sum }_{{k}_{2} = - {N}_{2} / 2}^{+ {N}_{2} / 2} {\sum }_{{k}_{1} = - {N}_{1} / 2}^{+ {N}_{1} / 2} \hat{u} ( k , t ) {e}^{- 2 πζ ( \frac{{k}_{1} {x}_{1}}{{L}_{1}} + \frac{{k}_{2} {x}_{2}}{{L}_{2}} + \frac{{k}_{3} {x}_{3}}{{L}_{3}} )} \qquad ( 21 )$$

$${u}^{N} ( x ) = {\sum }_{{k}_{3} = - {N}_{3} / 2}^{+ {N}_{3} / 2} {\sum }_{{k}_{2} = - {N}_{2} / 2}^{+ {N}_{2} / 2} {\sum }_{{k}_{1} = - {N}_{1} / 2}^{+ {N}_{1} / 2} \hat{μ} ( k ) {e}^{- 2 πζ ( \frac{{k}_{1} {x}_{1}}{{L}_{1}} + \frac{{k}_{2} {x}_{2}}{{L}_{2}} + \frac{{k}_{3} {x}_{3}}{{L}_{3}} )} \qquad ( 22 )$$

A uniform discretization of the spatial domain can be selected, with the same number of nodes as the Fourier modes in the truncations of EQS. (21) and (22) in each direction:

$${x}_{ijl} = ( i Δ {x}_{1} , j Δ {x}_{2} , l Δ {x}_{3} ) , where Δ {x}_{1} = \frac{{L}_{1}}{{N}_{1}} ; Δ {x}_{2} = \frac{{L}_{2}}{{N}_{2}} ; Δ {x}_{3} = \frac{{L}_{3}}{{N}_{3}} \qquad ( 23 )$$

$$and = \{ 0 , … , {N}_{1} - 1 \} ; j = \{ 0 , … , {N}_{2} - 1 \} ; l = \{ 0 , … , {N}_{3} - 1 \} .$$

Thus, the DFT for u and μ can be represented as:

$$\tilde{u} ( k , t ) = {\sum }_{l = 0}^{{N}_{3} - 1} {\sum }_{j = 0}^{{N}_{2} - 1} {\sum }_{i = 0}^{{N}_{1} - 1} {u}^{N} ( {x}_{ijl} , t ) {e}^{- 2 πζ ( \frac{{k}_{1} i}{{N}_{1}} + \frac{{k}_{2} j}{{N}_{2}} + \frac{{k}_{3} l}{{N}_{3}} )} \qquad ( 24 )$$

$$\tilde{u} ( k ) = {\sum }_{l = 0}^{{N}_{3} - 1} {\sum }_{j = 0}^{{N}_{2} - 1} {\sum }_{i = 0}^{{N}_{1} - 1} {u}^{N} ( {x}_{ijl} ) {e}^{- 2 πζ ( \frac{{k}_{1} i}{{N}_{1}} + \frac{{k}_{2} j}{{N}_{2}} + \frac{{k}_{3} l}{{N}_{3}} )} , \qquad ( 25 )$$

and the inverse discrete Fourier transform (iDFT) for ũ and \tilde{μ} can be represented as:

$${u}^{N} ( {x}_{ijl} , t ) = \frac{1}{{N}_{3} {N}_{2} {N}_{1}} {\sum }_{{k}_{3} = - \frac{{N}_{3}}{2}}^{\frac{{N}_{3}}{2} - 1} {\sum }_{{k}_{2} = - \frac{{N}_{2}}{2}}^{\frac{{N}_{2}}{2} - 1} {\sum }_{{k}_{1} = - \frac{{N}_{1}}{2}}^{\frac{{N}_{1}}{2} - 1} \tilde{u} ( k , t ) {e}^{2 πζ ( \frac{{k}_{1} i}{{N}_{1}} + \frac{{k}_{2} j}{{N}_{2}} + \frac{{k}_{3} l}{{N}_{3}} )} \qquad ( 26 )$$

$${u}^{N} ( {x}_{ijl} ) = \frac{1}{{N}_{3} {N}_{2} {N}_{1}} {\sum }_{{k}_{3} = - {N}_{3} / 2}^{+ {N}_{3} / 2} {\sum }_{{k}_{2} = - {N}_{2} / 2}^{+ {N}_{2} / 2} {\sum }_{{k}_{1} = - {N}_{1} / 2}^{+ {N}_{1} / 2} \tilde{u} ( k ) {e}^{2 πζ ( \frac{{k}_{1} i}{{N}_{1}} + \frac{{k}_{2} j}{{N}_{2}} + \frac{{k}_{3} l}{{N}_{3}} )} \qquad ( 27 )$$

The PD Laplacian of u^{N} on the discretized domain can be expressed via one-point Gaussian quadrature as:

$$\begin{matrix}{ℒ}_{μ} {u}^{N} ( {x}_{ijl} , t ) = {\sum }_{m = 0}^{{N}_{3} - 1} {\sum }_{q = 0}^{{N}_{2} - 1} {\sum }_{p = 0}^{{N}_{1} - 1} {μ}^{N} ( {x}_{ijl} - {x}_{pqm} ) [ {u}^{N} ( {x}_{pqm} , t ) \\ - {μ}^{N} ( {x}_{ijl} , t ) ] Δ {x}_{1} Δ {x}_{2} Δ {x}_{3} \\ = {\sum }_{m = 0}^{{N}_{3} - 1} {\sum }_{q = 0}^{{N}_{2} - 1} {\sum }_{p = 0}^{{N}_{1} - 1} {μ}^{N} ( {x}_{ijl} \\ - {x}_{pqm} ) {u}^{N} ( {x}_{pqm} , t ) Δ {x}_{1} Δ {x}_{2} Δ {x}_{3} \\ - \{ {\sum }_{m = 0}^{{N}_{3} - 1} {\sum }_{q = 0}^{{N}_{2} - 1} {\sum }_{p = 0}^{{N}_{1} - 1} {μ}^{N} ( {x}_{ijl} \\ - {x}_{pqm} ) Δ {x}_{1} Δ {x}_{2} Δ {x}_{3} \} {μ}^{N} ( {x}_{ijl} , t ) \\ = [ {u}^{N} {*}_{𝕋} {u}^{N} ] ( {x}_{ijl} , t ) - {β}^{N} {u}^{N} ( {x}_{ijl} , t )\end{matrix} \qquad ( 28 )$$

Using the definitions for the truncated Fourier series representations and DFT operations described above, the circular convolution of μ and u can be represented as:

$$\begin{matrix}[ {u}^{N} {u}^{N} ] ( {x}_{ijl} , t ) = iDFT \{ DFT \{ [ {u}^{N} {u}^{N} ] ( {x}_{ijl} , t ) \} \} \\ = iDFT \{ Δ {x}_{1} Δ {x}_{2} Δ {x}_{3} DFT [ {\sum }_{m = 0}^{{N}_{3} - 1} {\sum }_{q = 0}^{{N}_{2} - 1} {\sum }_{p = 0}^{{N}_{1} - 1} {μ}^{N} ( {x}_{ijl} \\ - {x}_{pqm} ) {u}^{N} ( {x}_{pqm} , t ) ] \} \\ = iDFT [ Δ {x}_{1} Δ {x}_{2} Δ {x}_{3} \tilde{μ} ( k ) \tilde{u} ( k , t ) ]\end{matrix} \qquad ( 29 )$$

Using Fast Fourier Transform (FFT) algorithms to implement the DFT and iDFT, the cost for the DFT operation and its inverse is O(N log₂ N), where N=N₁N₂N₃ is the total number of nodes. Using a simplify notation u^{N} (Xᵢⱼₗ,t)=u_{ijl,t}^{N} and μ^{N}(Xᵢⱼₗ)=μᵢⱼₗ^{N}, the linear nonlocal operator in discrete form can be represented as:

$$\begin{matrix}{ℒ}_{μ} {u}^{N} {\vert}_{ijl , t} = {FFT}^{- 1} [ Δ {x}_{1} Δ {x}_{2} Δ {x}_{3} FFT ( {μ}_{ijl}^{N} ) FFT ( {u}_{ijl , t}^{N} ) ] \\ - {β}^{N} {u}_{ijl , t}^{N} ,\end{matrix} \qquad ( 30 )$$

where FFT and FFT⁻¹ refer to the FFT and inverse FFT operations, respectively, and:

$${β}^{N} = {\sum }_{l = 0}^{{N}_{3} - 1} {\sum }_{j = 0}^{{N}_{2} - 1} {\sum }_{i = 0}^{{N}_{1} - 1} {u}^{N} ( {x}_{ijl} ) Δ {x}_{1} Δ {x}_{2} Δ {x}_{3} , \qquad ( 31 )$$

For singular kernels

$${( lim}_{x \to 0} μ ( x ) = ∞ ,$$

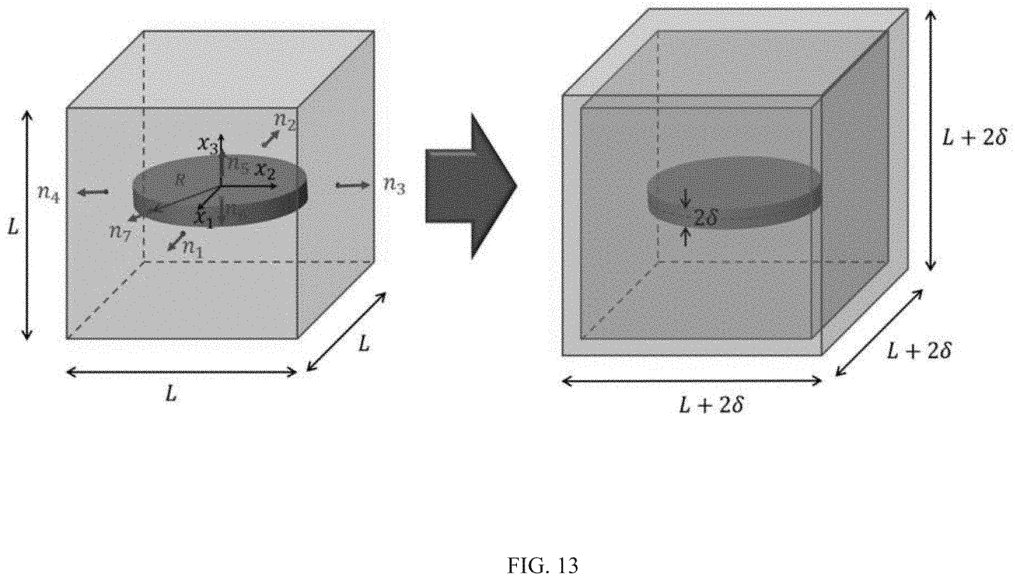

e.g. the kernel used in the example described in connection with FIGS. 13-16), μ^{N} [symbol] u^{N} and β^{N} become singular which make

$${ℒ}_{μ} {u}^{N} {\vert}_{ijl , t}$$

in EQ. (28) appear to be undefined, but in fact it is defined. The canceling pairs of terms leads to canceling singularities in μ^{N} [symbol] u^{N} and β^{N}, and leads to a value of zero for

$${ℒ}_{μ} {u}^{N} {\vert}_{ijl , t}$$

at the singularity point (ijl=pqm in EQ. (28)). In the actual implementation described below, the value of was set to zero (e.g.,

$${μ}^{N} ( {x}_{ijl} ) {\vert}_{{x}_{ijl} = 0} = 0 ) .$$

For integrable kernels, β can be calculated analytically at the continuum level formulation in EQ. (18). When using the discretized formulation, however, the β integral can be computed using the same discretization as the convolution term μ^{N} [symbol] u^{N}. Otherwise, discretization inconsistency between μ^{N} [symbol] u^{N} and β^{N} can undermine the accuracy of the computed

$${ℒ}_{μ} {u}^{N} .$$

Using r_{ijl,t} in place of r(xᵢⱼₗ,t), the spatially-discretized PD diffusion equation with the Fourier-based technique can be represented as:

$$\begin{matrix}\frac{{du}_{ijl , t}^{N}}{dt} = {vFFT}^{- 1} [ Δ {x}_{3} Δ {x}_{2} Δ {x}_{1} FFT ( {μ}_{ijl}^{N} ) FFT ( {u}_{ijl , t}^{N} ) ] \\ - v {β}^{N} {u}_{ijl , t}^{N} + {r}_{ijl , t}\end{matrix} \qquad ( 32 )$$

Using, for example, the forward Euler method in time for approximating the solution of the ordinary differential equation (ODE) in EQ. (32), yields:

$$\begin{matrix}{u}_{ijl , t + Δ t}^{N} = {u}_{ijl , t}^{N} \\ + Δ t \{ {vFFT}^{- 1} [ Δ {x}_{3} Δ {x}_{2} Δ {x}_{1} {\tilde{μ}}_{{k}_{1} {k}_{2} {k}_{3}} FFT ( {u}_{ijl , t}^{N} ) ] \\ - v {β}^{N} {u}_{ijl , t}^{N} + {r}_{ijl , t} \}\end{matrix} \qquad ( 33 )$$

Note that \tilde{μ}ₖ_{₁}ₖ_{₂}ₖ_{₃}=FFT(μᵢⱼₗ^{N}) can be precomputed just once, before the time integration loop, since it does not depend on time in this case.

The procedure described above for the isotropic homogeneous linear PD diffusion given in EQ. (5) can be extended to nonlinear cases in which the nonlinear PD operator is decomposable into convolutional terms. For example, in the case of the nonlinear diffusion with the time dependent properties given by EQS. (4) and (13), Fourier-based techniques can leads to the following discretization:

$$\begin{matrix}{u}_{ijl , t + Δ t}^{N} = {u}_{ijl , t}^{N} \\ + Δ t \{ \frac{1}{2} Δ {x}_{3} Δ {x}_{2} Δ {x}_{1} \{ {f}_{ijl , t}^{N} {FFT}^{- 1} [ FFT ( {ω}_{ijl , t}^{N} ) FFT ( {h}_{ijl , t}^{N} {u}_{ijl , t}^{N} ) ] \\ - {f}_{ijl , t}^{N} {u}_{ijl , t}^{N} {FFT}^{- 1} [ FFT ( {ω}_{ijl , t}^{N} ) FFT ( {h}_{ijl , t}^{N} ) ] \\ + {h}_{ijl , t}^{N} {FFT}^{- 1} [ FFT ( {ω}_{ijl , t}^{N} ) FFT ( {f}_{ijl , t}^{N} {u}_{ijl , t}^{N} ) ] \\ - {h}_{ijl , t}^{N} {u}_{ijl , t}^{N} {FFT}^{- 1} [ FFT ( {ω}_{ijl , t}^{N} ) FFT ( {f}_{ijl , t}^{N} ) ] \} + {r}_{ijl , t} \}\end{matrix} \qquad ( 34 )$$

Note that the only difference between the linear and nonlinear case is the discretized diffusion operator, because the nonlinear case utilizes more FFT and FFT⁻¹ calculations. In the example described above, the nonlinear case costs four times more than the linear case. However, the complexity for the nonlinear case remains O(N log₂ N).

In general, boundary conditions in PD nonlocal approaches are defined as volume constraints, defined over a δ thick volume layer on the domain exterior. For example, FIG. 3 shows a PD domain (Ω) and a boundary layer (Γ) extending a distance (δ) from a boundary of the domain Ω. A boundary between the domain Ω and the boundary layer Γ can be defined as ∂Ω. Note that although problems are generally described herein in up to three dimensions (e.g., in 1D, 2D, or 3D), these are examples, and mechanisms described herein can be used in connection with problems in any suitable number of dimensions.

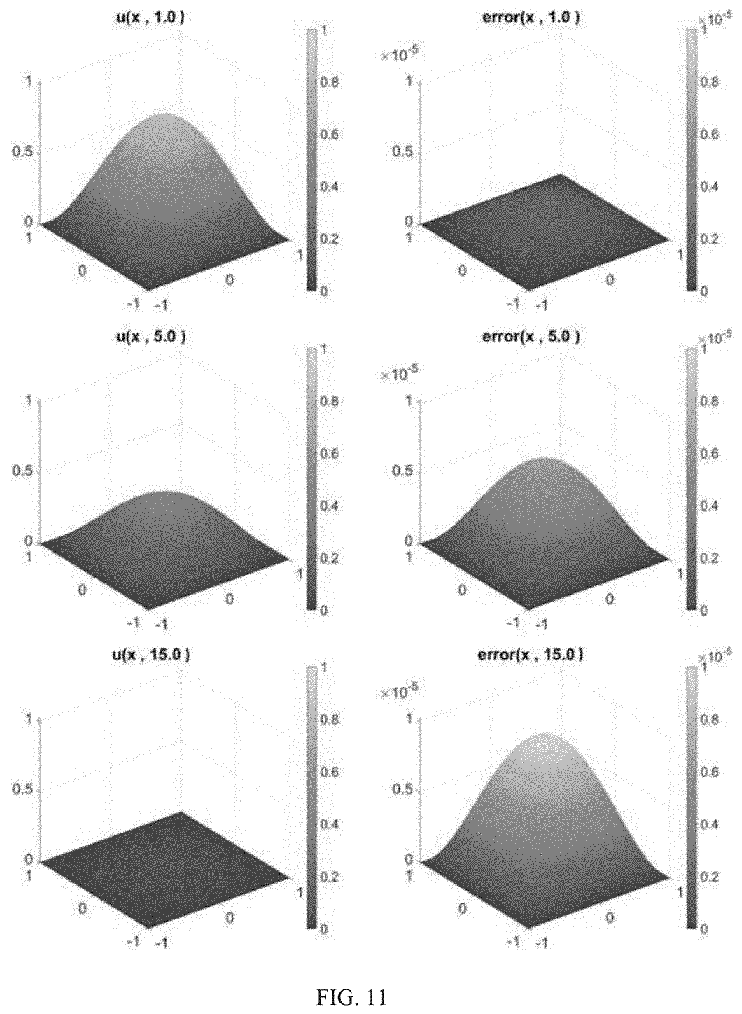

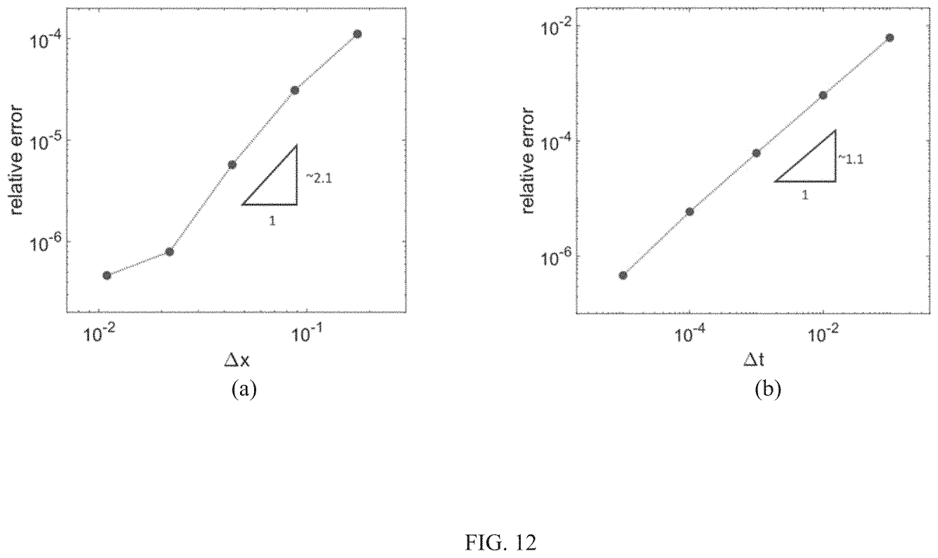

According to nonlocal vector calculus, volume-constrained peridynamic problems can be defined analogous to boundary value problems with partial differential equations (PDEs) in the local theory. For example, a volume constrained peridynamic transient diffusion problem can be generally expressed as:

$$\{ \begin{matrix}\frac{\partial u ( x , t )}{\partial t} = {ℒ}_{γ} u ( x , t ) + r ( x , t ) & x ∈ Ω , & t > 0 \\ u ( x , 0 ) = {u}_{0} ( initial conditions ) & x ∈ Ω & \\ G ( u ) = 0 ( volume constraints ) & x ∈ Γ , & t \geq 0\end{matrix} \qquad ( 35 )$$

where G is a function that prescribes the constraints of u on Γ. A solution for a problem with such volume constraints is described below in connection with FIGS. 11 and 12.

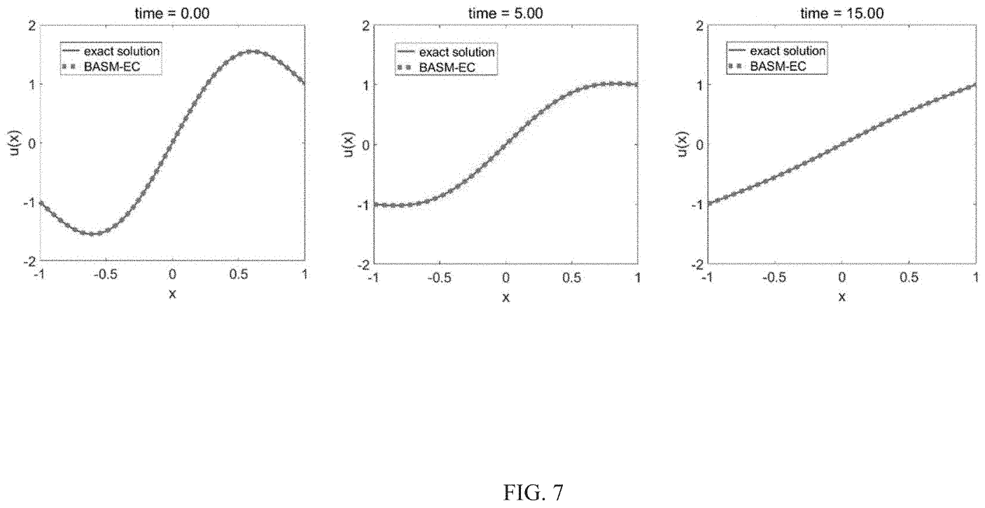

In many engineering problems, measurements are taken at the surfaces of a body, not through a layer near the surface. A natural representation of such measurements can be implemented via local boundary conditions. Techniques for imposing local boundary conditions on peridynamic bodies have been proposed. One such technique is a fictitious layer/nodes technique (e.g., as described below in connection with FIG. 22) where a certain volume constraint is considered on Γ, leading to desired boundary conditions on ∂Ω. This technique is exact in 1D and reasonably accurate in 2D and 3D (except at regions with high gradients, corners and sharp curvatures). This is used in examples described below in connection with FIGS. 7-10 and 13-16 to enforce local boundary conditions in two PD problems, by determining the corresponding volume constraint values on the boundary layer Γ. Details for imposing Dirichlet and Neumann BCs to peridynamic models are described in Appendix A, which is hereby incorporated by reference herein in its entirety.

FIG. 5 shows an example of the peridynamic domain of FIG. 4 surrounded by a periodic box that can be used to extend the bounded-domain peridynamic model into a periodic domain in accordance with some embodiments of the disclosed subject matter. FIG. 5 illustrates a technique that can be used to extend the Fourier-based techniques described above in connection with FIG. 4, to bounded domains with arbitrary boundary conditions.

As described above, while domain periodicity is a requirement for Fourier-based techniques, modifications have been introduced for local theories to solve problems with non-periodic boundary conditions. For example, as described above, a volume penalization technique can be used to solve problems with non-periodic volume constraints in 1D peridynamic diffusion using a Fourier-based technique. In some embodiments, mechanisms described herein can be used to implement simpler, more general, and more efficient techniques to impose non-periodic boundary conditions in the solution of PD models.

Using a generic irregular domain (Ω) and its boundary layer (Γ) as an example, to utilize mechanisms described herein, for solving the following volume-constrained problem:

$$\{ \begin{matrix}\frac{\partial u ( x , t )}{\partial t} = {ℒ}_{γ} u ( x , t ) + r ( x , t ) & x ∈ Ω , t > 0 \\ u ( x , 0 ) = {u}_{0} & x ∈ Ω \\ u ( x , t ) = ℊ ( x , t ) & x ∈ Γ , t \geq 0\end{matrix} \qquad ( 36 )$$

a periodic box ( [symbol] ) can be placed around the domain and boundary layer (e.g., Ω∪Γ), as shown in FIG. 5. The region(s) that is bounded by the periodic box, but not part of either the domain or the boundary layer (e.g., [symbol] \(Ω∪Γ)) can be denoted as Λ and is sometimes referred to herein as the gap region.

The volume-constrained problem in EQ. (36) can be replaced with the following periodic problem:

$$\{ \begin{matrix}\frac{\partial u ( x , t )}{\partial t} = χ ( x , t ) [ {ℒ}_{γ} u ( x , t ) + r ( x , t ) ] + [ 1 - χ ( x , t ) ] \frac{\partial w ( x , t )}{\partial t} & x ∈ , t > 0 \\ u ( x , 0 ) = {u}_{0} & x ∈\end{matrix} \qquad ( 37 )$$

where χ denotes the mask function:

$$χ ( x ) = \{ \begin{matrix}1 & x ∈ Ω \\ 0 & x ∈ \backslash Ω = Γ ⋃ Λ\end{matrix} \qquad ( 38 )$$

$$and :$$

$$\begin{matrix}w ( x , t ) = \{ \begin{matrix}0 & x ∈ Ω \\ ℊ ( x , t ) & x ∈ Γ \\ z ( x , t ) & x ∈ Λ\end{matrix} & ( 39 )\end{matrix}$$

where g(x,t) is the volume constraint given by the original problem defined in EQ. (36), and z(x,t) is a function describing gap values.

Note that both classical (local) Dirichlet and Neumann boundary conditions can be handled by the volume-constrained problem description provided in EQ. (36). For example, certain profiles of g(x,t) can be chosen such that effectively a classical Dirichlet or a classical Neumann boundary condition is enforced at the domain boundary ∂Ω. The particular type of classical boundary conditions to be enforced can be specified by a proper choice of the g function in EQ. (36). Further examples of techniques that can be used to specify g for Dirichlet or Neumann boundary conditions are provided in Appendix A as EQS. (A.2) and (A.4).

Note that unlike the constraint g, gap values (z) do not directly interact with u on Ω, since Λ and Ω are more than a horizon size apart (e.g., as shown in FIG. 5), and therefore, in principle, they can be chosen arbitrarily (e.g., zero can be chosen, for example). This may lead to non-smoothness at the Γ/Λ interface. While such a lack of smoothness in the extensions may be expected to lead to associated errors (e.g., Gibbs-type phenomenon), numerical experiments, so far, indicate no oscillations are produced. The absence of the Gibbs oscillations were also investigated when non-smooth extensions are used for elastic problems. Additionally, smooth extensions can be generated using approaches available in the literature for the local model (e.g., as described in Canuto et al., “Spectral methods,” Springer, 2006, and Bueno-Orovio et al., “Spectral methods for partial differential equations in irregular domains: the spectral smoothed boundary method,” SIAM Journal on Scientific Computing, 28 (2006) 886-900. Also, note that smoothing effects are expected to be introduced in a convolution setting.

Having replaced the original volume-constrained problem with a periodic problem, the Fourier collocation techniques described above in connection with FIG. 4 can be used to spatially discretize the periodic problem. In some embodiments, the domain [symbol] can be discretized according to the EQ. (23), then the problem of EQ. (37) can be defined as becomes the following initial value problem for a system of ordinary differential equations (ODEs):

$$\{ \begin{matrix}{\frac{{du}_{ijl , t}^{N}}{dt} = {χ}_{ijl} ( {ℒ}_{γ} u \vert}_{ijl , t} + {r}_{ijl , t} ) + ( 1 - {χ}_{ijl} ) \frac{{dw}_{ijl , t}}{dt} & x ∈ , \\ {u}_{ijl , t = 0} = {u}_{0 , ijl} & x ∈\end{matrix} \qquad ( 40 )$$

$$where$$

$${χ}_{ijl} = \{ \begin{matrix}1 & {x}_{ijl} ∈ Ω \\ 0 & {x}_{ijl} ∈ Γ ⋃ Λ\end{matrix} \qquad ( 41 )$$

$$and$$

$${w}_{ijl , t} = \{ \begin{matrix}0 & {x}_{ijl} ∈ Ω \\ {ℊ}_{ijl , t} & {x}_{ijl} ∈ Γ \\ {z}_{ijl , t} & {x}_{ijl} ∈ Λ\end{matrix} \qquad ( 42 )$$

[symbol]

_{γ}u|_{ijl,t} is the discrete peridynamic Laplacian operator calculated via Fourier transform as described above in connection with FIG. 4. Note that the particular formula for [symbol] _{γ}u|_{ijl,t} can depend on the kernel inside the operator (see EQS. (30) and (34) as two examples).

Using EQ. (41), the system of ODEs in EQ. (40) can be rewritten as:

$$\frac{{du}_{ijl , t}^{N}}{dt} = \{ \begin{matrix}{{ℒ}_{γ} u \vert}_{ijl , t} + {r}_{ijl , t} & {x}_{ijl} ∈ Ω \\ \frac{{dw}_{ijl , t}}{dt} & {x}_{ijl} ∈ Γ ⋃ Λ\end{matrix} \qquad ( 43 )$$

In some embodiments, the system of ODEs in EQ. (43) can be solved using an ODE solver (e.g., the forward Euler scheme was used). Knowing u=w on [symbol] \Ω, EQ. (43) can be (approximately) solved using the following forward Euler scheme:

$${u}_{ijl , t + Δ t}^{N} = \{ \begin{matrix}{u}_{ijl , t}^{N} + Δ t ( {{ℒ}_{γ} u \vert}_{ijl , t} + {r}_{ijl , t} ) & {x}_{ijl} ∈ Ω \\ {w}_{ijl , t + Δ t} & {x}_{ijl} ∈ Γ ⋃ Λ\end{matrix} \qquad ( 44 )$$

Additionally, EQ. (41) can be used to re-write EQ. (44) as:

$$\begin{matrix}{u}_{ijl , t + Δ t}^{N} = {χ}_{ijl} [ {u}_{ijl , t}^{N} + Δ t ( {{ℒ}_{γ} u \vert}_{ijl , t} + {r}_{ijl , t} ) ] \\ + ( 1 - {χ}_{ijl} ) {w}_{ijl , t + Δ t}\end{matrix} \qquad ( 45 )$$

In some embodiments, techniques for imposing volume constraints described above in connection with EQS. (40) to (45) can be referred to as “embedded constraint” techniques, as the constraints can be embedded into the governing integro-differential equation.

In some embodiments, when using the forward Euler scheme to solve the system of (time dependent) ODEs in EQ. (43), a time step restriction has to be imposed. For example, using a stability analysis described in Jafarzadeh, et al., “Efficient solutions for nonlocal diffusion problems via boundary-adapted spectral methods,” Journal of Peridynamics and Nonlocal Modeling, 2 (2020) 85-110, the stability condition in the absence of a penalization term for linear diffusion results in:

$$Δ t \leq \frac{1}{v β} \qquad ( 46 )$$

This condition implies that stability does not depend on the spatial discretization resolution, but depends on the horizon size (δ) and the kernel function. This condition is somewhat similar to the Courant-Friedrichs-Lew (CFL) condition in the meshfree method. In the volume penalization technique described in Jafarzadeh et al., (which is summarized in Appendix B, which is hereby incorporated herein by reference), higher accuracy may require a potentially larger penalization parameter which may shrink the maximum allowed time step, and consequently increase the computational cost. An advantage of embedded constraint techniques described herein compared with volume penalization is that the maximum time step size does not depend on a penalization parameter. Note that this is an example specific to the forward Euler scheme and explicit time integration for a time-dependent problem. Other approaches can be used in connection with different techniques for solving the system of ODEs and/or other types of problems, which may utilize a different time step restriction or no restriction. For example, a-stable time integration can be used without imposing a restriction on time step size. As another example, a time step restriction is not needed for problems that are not time dependent (e.g., steady state diffusion, static or quasi-static deformation, etc.). In such an example, a load step (e.g., of any suitable size) may be used. In a particular example, a peridynamic solution to a quasistatic deformation using FCBM techniques is described in Appendix D.

Another advantage of embedded constraint techniques described herein over volume penalization is that embedded constraint techniques can be applied directly to other PD equations (e.g., PD equations of motion), while the volume penalization technique cannot without modification. For example, the specifics of the volume penalization techniques depend on whether PDEs are solved with first-order or second-order partial derivatives in time.

FIG. 6 shows an example 600 of a process for efficient peridynamic modeling with bounded domains in accordance with some embodiments of the disclosed subject matter. At 602, process 600 can receive parameters associated with a peridynamic model of a system to be analyzed. In some embodiments, process 600 can receive the parameters using any suitable technique or combination of techniques. For example, process 600 can receive parameters at 602 via a user interface, such as a graphical user interface (e.g., a graphical user interface presented by a display of a computing device executing at least a portion of process 600, such as display 204 of computing device 16), or other user interface. As another example, process 600 can receive parameters at 602 from another device. In a more particular example, process 600 can receive parameters from another computing device (e.g., computing device 16 can receive parameters from server 120, or server 120 can receive parameters from computing device 16). As another more particular example, process 600 can receive the parameters from a portable storage device (e.g., a portable memory device, such as a USB flash drive, an optical disk, etc.). In such examples, the parameters can be formatted using any suitable format, such as a file (e.g., a .txt. file, a .m file, an XML, file, etc.)

In some embodiments, the parameters received at 602 can include any suitable parameters that can be used to specify characteristics of a simulation (e.g., characteristics of a problem to be solved), such as physical parameters, initial conditions, boundary conditions, number of nodes (e.g., in each dimension), and/or time step size

$$( e . g . , Δ t \leq \frac{1}{v β} ) .$$

For example, the parameters can include a type of simulation to be performed (e.g., a simulation of diffusion, a simulation of brittle fracture, etc.). As another example, the parameters can include information identifying one or more materials to be modeled. As yet another example, the parameters can include a shape of a domain(s) to be modeled (e.g., a shape of the domain Ω). As still another example, the parameters can include initial conditions associated with a problem to be solved (e.g., u₀=u(x, t=0)).

As a further example, the parameters can include boundary conditions to be applied (e.g., u_{b}=u(Ω,t)|_{∂Ω}_{_{D}}, or q_{b}=∇u(⋅,t)·n|_{∂Ω}_{_{N}}). As another further example, the parameters can include information indicative of an external force(s) to be applied to the model (e.g., the parameters can include a bias term and/or information that can be used to define a bias term, such as a source term r(x,t), or an external body force density term b(x,t)).

As yet another further example, the parameters can include information indicative of a function that can be used to simulate interactions between different portions of a model. In a more particular example, the parameters can include a kernel(s) associated with the material(s) to be modeled, such as γ(x) or μ(x), as described above in connection with EQS. (4), (6), (11), and (12)). As another more particular example, the parameters can include a kernel(s) associated with models of deformation and/or fracture, such as C(x) or a(x), as described in Appendix D.

As still another further example, the parameters can include any other suitable physical parameters, such as a scalar diffusivity constant (e.g., ν), a horizon size (e.g., δ), the maximum time of the simulation (e.g., tₘₐₓ), and/or any other suitable physical parameters. In some embodiments, process 600 can derive additional parameters (e.g., β, an integral of a kernel function) from the received parameters.

At 604, process 600 can retrieve a convolutional function(s) and/or a bias term(s) that can be used to simulate interactions between different portions of a peridynamic model. For example, based on the type of simulation to be performed, one or more material(s) included in a body to be modeled, etc., process 600 can retrieve one or more appropriate kernel functions that can be used to simulate interactions between different portions of the model. In some embodiments, kernel functions that can be used to model various different problems (e.g., involving different materials, involving different processes, etc.) can be developed and made accessible to a device executing process 600 (e.g., as part of a software package that executes process 600, from a server via an API, etc.).

As another example, based on the type of simulation to be performed, one or more material(s) included in a body to be modeled, etc., process 600 can retrieve one or more bias terms (e.g., a source term r(x,t), an external body force density term b(x,t), etc.) that can be used to simulate interactions between an environment and the model. In some embodiments, bias terms that can be used to model various different problems (e.g., involving different materials, involving different processes, etc.) can be developed and made accessible to a device executing process 600 (e.g., as part of a software package that executes process 600, from a server via an API, etc.).

At 606, process 600 can draw a periodic box around the peridynamic model and a boundary region (e.g., Γ) using any suitable technique or combination of techniques. For example, as described above in connection with FIG. 5, process 600 can draw a box [symbol] around the peridynamic model.

Additionally, in some embodiments, process 600 can initialize the peridynamic model using any suitable technique or combination of techniques. For example, process 600 can calculate grid spacing (e.g., for a 3D model, process 600 can calculate grid spacing long three axes as:

$$Δ {x}_{1} = \frac{{L}_{1}}{{N}_{1}} , Δ {x}_{2} = \frac{{L}_{2}}{{N}_{2}} , Δ {x}_{3} = \frac{{L}_{3}}{{N}_{3}} ,$$

where Nₙ is the number of nodes along an axis, and Lₙ is a length of the periodic box [symbol] along the axis). Process 600 can discretize the box [symbol] : xᵢⱼₗ={xᵢ, xⱼ, xᵢ} where xᵢ=x₁⁰+(i−1)Δx₁ and i=1, 2, . . . , N₁, xⱼ=x₂⁰+(j−1)Δx₂ and j=1, 2, . . . , N₂, and xₗ=x₃⁰+(l−1)Δx₃ and l=1, 2, . . . , N₃. Process 600 can Discretize the kernel function μᵢⱼₗ=μ(xᵢⱼₗ). Process 600 can set μᵢⱼₗ|ₓ_{ᵢⱼₗ}₌0 (e.g., for singular kernels only). Process 600 can shift the discretized periodic kernel function (e.g., if x₁⁰, x₂⁰, or x₃⁰≠0): μᵢⱼₗ^{s}=μ(xᵢ−x₁⁰, xⱼ−x₂⁰, xₗ−x₃⁰) (note that this can be performed to align the lower bounds of the periodic box with zero, for example, to align the domain to zero for DFT formulations that are configured for such domains). Process 600 can discretize the initial condition and the source term or external body force density term (e.g., μᵢⱼₗ⁰=u₀(xᵢⱼₗ, 0); rᵢⱼₗ⁰=r(xᵢⱼₗ, 0); bᵢⱼₗ⁰=b(xᵢⱼₗ, t)). Process 600 can perform a Fast Fourier transform of μᵢⱼₗ^{s} and uᵢⱼₗ⁰: [symbol] ₖ_{₁}ₖ_{₂}ₖ_{₃}=FFT(μᵢⱼₗ^{s}) and [symbol] ₖ_{₁}ₖ_{₂}ₖ_{₃}=FFT(uᵢⱼₗ⁰). Process 600 can construct the discretized mask function:

$${χ}_{ijl} = \{ \begin{matrix}1 & {x}_{ijl} ∈ Ω \\ 0 & {x}_{ijl} ∈ \backslash Ω = Γ ⋃ Λ\end{matrix} .$$

Process 600 can initialize a step counter to n=0. Process 600 can initialize a current time to tⁿ=0.

At 608, process 600 can generate periodic boundary conditions based on the parameters received at 602 using any suitable technique or combination of techniques. For example, process 600 can generate volume constraints based on received local boundary conditions using techniques described above in connection with EQS. (36) to (39), and in Appendix A. In a more particular example, process 600 can construct the variable containing volume constraints and gap values (w), for example, by allocating wᵢⱼₗ=0, calculating and assigning volume constraints on F based on given boundary conditions and techniques described in Appendix A: wᵢⱼₗ|_{Γ,t=0}, and calculating and assign values on the gap (if Λ≠Ø): wᵢⱼₗ|_{Λ,t=0}.

At 610, process 600 can perform a peridynamic simulation of the model based on parameters received at 602, the kernel(s) received at 602 and/or retrieved at 604, and the periodic boundary conditions generated at 608. For example, as described above in connection with EQS. (14) to (34), process 600 can use Fourier-based techniques to perform a peridynamic simulation from an initial time to a final time (e.g., advancing a time step Δt).

In a more particular example, process 600 can update a current time based on the time step, and update a solution for the new time until the time has reached the maximum time (e.g., tⁿ⁺¹=tⁿ+Δt) Process 600 can update a solution to the peridynamic equation at the new time (e.g., in the 3D example described below in connection with FIGS. 13-16 the solution at time step n+1 can be determined using the relationship uᵢⱼₗⁿ⁺¹=χᵢⱼₗ(uᵢⱼₗⁿ+Δt{νFFT⁻¹[Δx₃Δx₂Δx₁\tilde{μ}ₖ_{₁}ₖ_{₂}ₖ_{₃}FFT(uᵢⱼₗⁿ)]−νβⁿuᵢⱼₗⁿ+rᵢⱼₗ})+(1−χᵢⱼₗ)wᵢⱼₗⁿ). Process 600 can update the source term or force density term (e.g., in the 3D example described below in connection with FIGS. 13-16 the source term at time step n+1 can be determined using the relationship rᵢⱼₗⁿ⁺¹=rᵢⱼₗ(xᵢⱼₗ, tⁿ⁺¹). Process 600 can re-apply volume constraints and gap values by updating the term wᵢⱼₗⁿ⁺¹ (e.g., based on EQ. 39). Process 600 can update the step counter (e.g., n=n+1). Process 600 can repeatedly update the solution (e.g., using the preceding techniques) until a maximum time is reached).

At 612, process 600 can present results of the peridynamic analysis using any suitable technique, and/or cause results of the peridynamic analysis to be presented. For example, process 600 can present a static state of the simulation at a particular time step or time steps. As another example, process 600 can present a series of states of the simulation at a series of time steps (e.g., as an animation). In some embodiments, process 600 can cause the results to be presented by a computing device executing process 600 (e.g., if computing device 16 is executing process 600, process 600 can cause the results to be presented by a display device associated with computing device 16). Additionally or alternatively, in some embodiments, process 600 can cause the results to be presented by another computing device (e.g., that is not executing process 600, or is executing only a portion of process 600). For example, if server 120 is executing process 600, process 600 can cause the results to be presented by computing device 16.

FIG. 7 shows examples comparing numerical solutions to a 1D nonlocal diffusion problem with two Dirichlet (non-periodic) boundary conditions determined using mechanisms described herein and the exact solution for the problem at various times.

Described below in connection with FIGS. 7-16, the accuracy and convergence of mechanisms described herein for efficient peridynamic modeling with bounded domains is numerically evaluated for various examples, including a 1D peridynamic linear diffusion example with non-periodic boundary conditions, a 2D volume-constrained peridynamic nonlinear diffusion problem, and a 3D diffusion problem with non-periodic local boundary conditions using mechanisms described herein.

To evaluate the performance of mechanisms described herein in terms of accuracy and convergence, mechanisms described herein were used to solve a PD problem for which the analytical solution is known (based on the method of manufactured solutions). Consider the following 1D PD linear diffusion problem on the bounded domain

$$Ω = [ - \frac{L}{2} , \frac{L}{2} ] :$$

$$\frac{\partial u ( x , t )}{\partial t} = v {\int }_{{ℋ}_{x}} μ ( {x}^{′} - x ) [ u ( {x}^{′} ) - u ( x ) ] {dx}^{′} + r ( x , t ) \qquad ( 47 )$$

$$where :$$

$$\begin{matrix}μ ( x ) = \{ \begin{matrix}\frac{12}{{δ}^{3}} ( 1 - \frac{\vert x \vert}{δ} ) ; & \vert x \vert \leq δ \\ 0 ; & \vert x \vert > δ\end{matrix} & ( 48 )\end{matrix}$$

$$and$$

$$\begin{matrix}r ( x , t ) = v \{ \frac{6 {L}^{2}}{{δ}^{4} {π}^{2}} [ cos ( \frac{2 πδ}{L} ) - 1 ] + \frac{12}{{δ}^{2}} \\ - 1 \} {e}^{- vt} sin ( \frac{2 π x}{L} ) ,\end{matrix} \qquad ( 49 )$$

with the initial condition:

$$u ( x , 0 ) = \frac{2 x}{L} + sin ( \frac{2 π x}{L} ) , \qquad ( 50 )$$

and subjected to Dirichlet boundary conditions:

$$u ( - \frac{L}{2} , t ) = - 1 \qquad ( 51 )$$

$$u ( \frac{L}{2} , t ) = 1 \qquad ( 52 )$$

The exact analytical solution to the above problem is:

$$u ( x , t ) = \frac{2 x}{L} + {e}^{- vt} sin ( \frac{2 π x}{L} ) \qquad ( 53 )$$

In order to use mechanisms described herein the bounded domain

$$Ω = [ - \frac{L}{2} , \frac{L}{2} ]$$

is extended by a length δ on both ends to create the boundary volumes (Γ). In the extended domain

$$= [ - \frac{L}{2} - δ , \frac{L}{2} + δ ) ,$$

volume constraints should be specified on

$${Γ}_{1} = [ - \frac{L}{2} - δ , - \frac{L}{2} ) and {Γ}_{2} = ( \frac{L}{2} , \frac{L}{2} + δ ]$$

as the left and the right boundary layers. In this example, [symbol] =Ω∪Γ is considered to be periodic; therefore no gap region is included (i.e., Λ=Ø). There are multiple alternatives for applying the local boundary conditions given in EQS. (51) and (52). For example, the exact volume constraints can be used (because the exact, manufactured solution for the nonlocal problem is known). As another example, a technique for constructing volume constraints based on the given local boundary conditions (e.g., as described in Appendix A). In order to compare with the results generated using the volume penalization technique described in Jafarzadeh et al., the second approach was used. This example also demonstrates how local boundary conditions can be applied to a general peridynamic problem, even when the nonlocal analytical solution is not known.

In this example, L=2, ν=0.2, δ=0.2, the total diffusion time tₘₐₓ=15, and the expression [symbol] =[−1.2, 1.2) can describe the periodic extended domain with −1.2 identified with 1.2. Additionally N=2⁹ total nodes were used with Δt=1.67×10⁻² as the maximum time step allowed by EQ. (46). FIG. 7 shows the numerical results generated using techniques described herein (labeled as FCBM-EC) versus the exact solution. As shown in FIG. 7, boundary conditions were correctly enforced using mechanisms described herein.

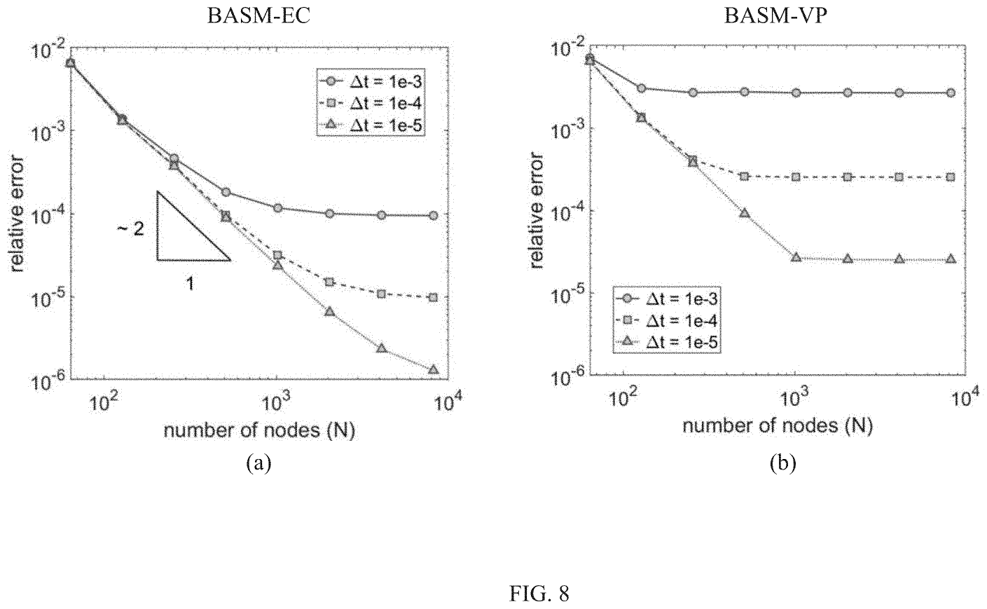

FIG. 8 shows example convergence studies in terms of spatial resolution for three time step sizes based on results determined using mechanisms described herein and results determined using another technique.

A convergence test was performed on this example to study the influence of spatial and temporal resolutions on the maximum relative error:

$${max}_{0 < t < {t}_{max}} \frac{{‖ {u}_{i , t} - {u}_{i , t}^{N} ‖}_{∞}}{{‖ {u}_{i , t = 0} ‖}_{∞}} .$$

In peridynamics the ratio

$$m = \frac{δ}{Δ x}$$

is usually referred to as “m factor” which is a measure for family node density. For convergence tests in terms of spatial discretization, the spatial discretization is refined while keeping the horizon size fixed. This is sometimes referred to as “m-convergence”. The number of nodes was varied from N=2⁶ to 2¹³ (m varied from 5.3 to 682.7 accordingly). Results are presented in FIG. 8, panel (a). A similar convergence study using the volume penalization technique described in Jafarzadeh et al., and the results are shown in FIG. 8, panel (b).

Comparing results in FIG. 8, panels (a) and (b), the simulation performed using mechanisms described herein are more accurate than the volume penalization approach for the same time step size. Note that the temporal resolution in the volume penalization technique is tied to penalization parameter (E) magnitude. For each time step, the smallest possible E was used to test the optimum performance of the two approaches. For both approaches, the rate of convergence is O(Δx²) for sufficiently small Δt.

Note that in most cases, Fourier-based techniques described herein show spectral accuracy for smooth functions. From the convergence study shown in FIG. 8, mechanisms described herein produced quadratic accuracy, not “spectral” accuracy. However, the mechanisms described herein can still be referred to as “spectral” given the use of global and smooth functions in the Fourier series representations of the kernel and the unknown functions. Techniques using such basis functions are generally termed as “spectral”.

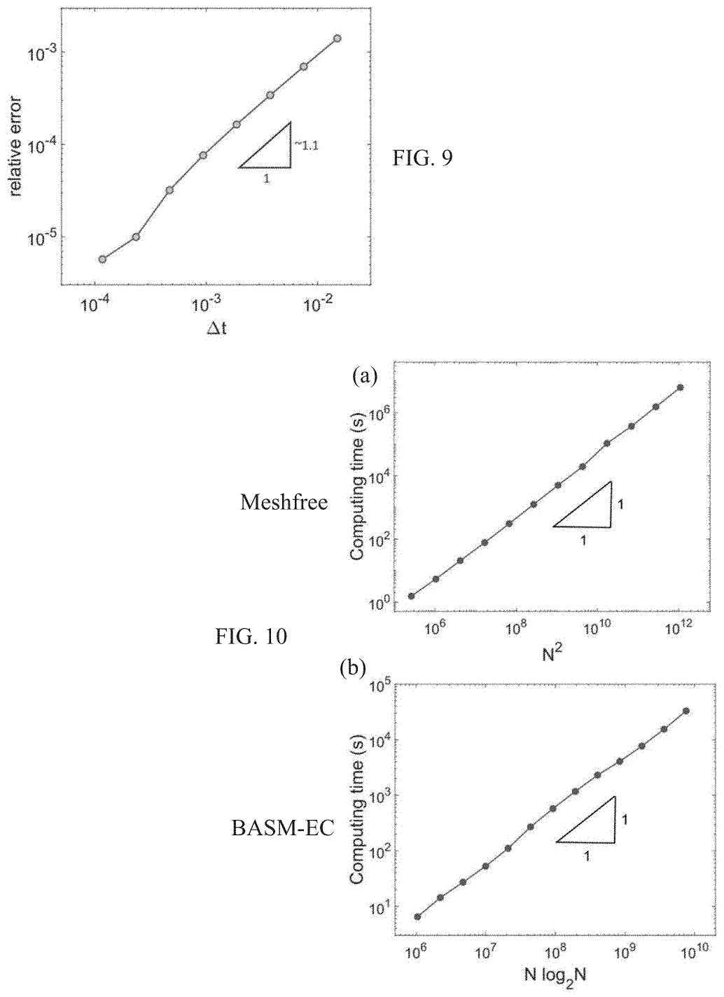

FIG. 9 shows an example convergence study in terms of spatial resolution based on results determined using mechanisms described herein for a 1D diffusion example with non-periodic boundary conditions. Although FIG. 8, panel (a) shows the error for three different time steps, a separate temporal convergence test was conducted with spatial resolution fixed at N=2¹³ (m=682.7). A linear rate of convergence, O(Δt), can be observed, which is expected from the Forward Euler time integrator. Methods with higher order accuracy (e.g., explicit 4^{th} order Runge-Kutta) can be used for temporal integration. In that case, the stability restriction on time step size for explicit methods would be different from that shown in EQ. (46).

FIG. 10 shows examples of computational complexity of a meshfree technique and techniques described herein for solving a 1D diffusion example with non-periodic boundary conditions. To check the computational complexity for the meshfree method using direct quadrature, and mechanisms described herein using the FFT, the 1D problem described above in connection with FIG. 7 was solved, considering various spatial discretization sizes. The meshfree method was performed using N=2⁹ to 2²⁰ and a simulation utilizing mechanisms described herein was performed with N=2¹⁶ to 2²⁸. The time step in all these tests was Δt=1.67×10⁻². Simulations were conducted using a Dell-Precision T7810 workstation PC, Intel® Xeon® CPU E5-2687 W v3@3.10 GHz logical processors, and 64 GB of installed memory. We utilized only one CPU for these computations. FIG. 7 shows the computational run times for each method, relative to the problem size.

As expected, the complexity of meshfree method with direct quadrature was O(N²) (e.g., as shown in FIG. 10, panel (a)), while for the simulation performed using mechanisms described herein FCBM-EC we find it to be O(N log₂ N) (e.g., as shown in FIG. 10, panel (b)).

FIG. 11 shows examples of numerical solutions of a 2D nonlinear volume-constrained peridynamic transient diffusion problem determined using mechanisms described herein for efficient peridynamic modeling with bounded domains. The images in the left column of FIG. 11 show the solution to the 2D problem described below generated using mechanisms described herein at three times (t=1, 5, and 15), and the right column shows the corresponding relative error distribution compared with the exact nonlocal solution.

The method of manufactured solutions was used to construct a 2D nonlinear volume-constrained peridynamic transient diffusion problem. Consider the following function:

u(x,t)=e^{-0.2t}(1−x₁²)(1−x₂²),x={x₁,x₂}∈ [symbol] ² and t≥0 (54)

EQ. (54) is the analytical solution to the following nonlinear problem:

$$\{ \begin{matrix}\frac{\partial u ( x , t )}{\partial t} = {ℒ}_{γ} u ( x , t ) + r ( x , t ) & x ∈ Ω = {[ - 1 , 1 ]}^{2} , t > 0 \\ u ( x , 0 ) = ( 1 - {x}_{1}^{2} ) ( 1 - {x}_{2}^{2} ) & x ∈ Ω = {[ - 1 , 1 ]}^{2} \\ u ( x , t ) = {e}^{- 0.2 t} ( 1 - {x}_{1}^{2} ) ( 1 - {x}_{2}^{2} ) & x ∈ Γ = {[ - 1.2 , 1.2 ]}^{2} {\text{\textbackslash [} - 1 , 1 ]}^{2} , t \geq 0\end{matrix} \qquad ( 55 )$$

$$Where$$

$${ℒ}_{γ} u ( x , t ) = γ ( {x}^{′} , x ) [ u ( {x}^{′} , t ) - u ( x , t ) ] {dx}^{′} \qquad ( 56 )$$

$$with$$

$$γ ( {x}^{′} , x ) = u ( x , t ) u ( {x}^{′} , t ) ω ( {x}^{′} - x ) \qquad ( 57 )$$

$$and$$

$$ω ( x ) = 0.2 ( 1 - \frac{‖ x ‖}{δ} ) . \qquad ( 58 )$$

Note that this is a special case of EQ. (13) where f=h=u. If U is temperature for example, with this kernel, EQ. (55) is a nonlinear PD problem with temperature dependent diffusivity. In EQ. (55):

$$\begin{matrix}r ( x , t ) = \frac{- 0.2 π {e}^{- 0.6 t}}{443520} ( 1 - {x}_{1}^{2} ) ( 1 - {x}_{2}^{2} ) [ 189 {δ}^{10} \\ + {δ}^{8} ( 4620 {x}_{1}^{2} + 4620 {x}_{2}^{2} - 3080 ) \\ + {δ}^{6} ( 7920 {x}_{1}^{4} + 92400 {x}_{1}^{2} {x}_{2}^{2} - 44880 {x}_{1}^{2} \\ + 7920 {x}_{2}^{4} - 44880 {x}_{2}^{2} + 23760 ) \\ + {δ}^{4} ( 110880 {x}_{1}^{4} {x}_{2}^{2} - 22176 {x}_{1}^{4} + 110880 {x}_{1}^{2} {x}_{2}^{4} \\ - 443520 {x}_{1}^{2} {x}_{2}^{2} + 155232 {x}_{1}^{2} - 22176 {x}_{2}^{4} \\ + 155232 {x}_{2}^{2} - 44352 ) + 44352 {e}^{0.4 t} ]\end{matrix} \qquad ( 59 )$$

Assuming δ=0.4, consider Ω∪Γ=[−1.4,1.4]² can be the 2D periodic box [symbol] to solve the problem using mechanisms described herein. Note that for this example there is also no gap region (i.e., Λ=Ø). The domain is discretized with uniform grid spacing in both directions: N₁=N₂=2⁷ which results in an m factor of 36.6. The numerical solution using techniques described herein is calculated from:

u_{ij,t+Δt}^{N}=χᵢⱼ[u_{ij,t}^{N}+Δt( [symbol] _{γ}u|_{ij,t}+r_{ijl,t})]+(1−χᵢⱼ)w_{ij,t+Δt} (60)

where

[symbol]

_{γ}u|_{ij,t}=0.2Δx₂Δx₁{u_{ij,t}^{N}FFT⁻¹[FFT(ω_{ij,t}^{N})FFT((u_{ij,t}^{N})²)]−(u_{ij,t}^{N})²FFT⁻¹[FFT(ω_{ij,t}^{N})FFT(u_{ij,t}^{N})]} (61)

EQ. (61) was obtained when substituting f and h with U in EQ. (34). EQ. (61) was computed to solve this nonlinear transient problem up to t=15 with Δt=0.01. Simulation results for three snapshots at t=1, 5 and 15 are shown in the left column of FIG. 11. The relative error (shown in the right column of FIG. 11) was computed from:

$$error ( {x}_{ij} , t ) = \frac{\vert {u}_{ij , t}^{N} - {u}_{ij , t}^{exact} \vert}{{‖ {u}_{ij , 0} ‖}_{∞}} \qquad ( 62 )$$

This example shows that mechanisms described herein are capable of solving nonlinear volume-constrained PD diffusion problems in higher dimensions.

FIG. 12 shows examples of convergence studies in terms of spatial and temporal resolutions for the nonlinear 2D volume-constrained peridynamic transient diffusion problem determined using mechanisms described herein for efficient peridynamic modeling with bounded domains.

A spatial and temporal convergence study for the nonlinear 2D example described above in connection with FIG. 11 was also performed. For spatial convergence, a fixed Δt=10⁻⁵ (for 0<t≤5) was used, and m-factor was varied from 4.6 to 73.1 (N₁=N₂ from 2⁴ to 2⁸). For temporal convergence, a fixed spatial resolution of N₁=N₂=2⁸ (m=73.1) was used, and Δt was varied from 0.1 to 10⁻⁵ (for 0<t≤5). The results for these tests are shown in FIG. 12, with the results for spatial convergence shown in FIG. 12, panel (a), and the results for temporal convergence shown in FIG. 12, panel (b). Here, the relative error was computed by:

$${max}_{0 < t < 5} \frac{{‖ {u}_{ij , t} - {u}_{ij , t}^{N} ‖}_{∞}}{{‖ {u}_{ij , t = 0} ‖}_{∞}} .$$

Similar to the 1D example, the convergence rate is quadratic in terms of Δx and linear in terms of Δt (due to the Forward Euler time integrator) for this 2D nonlinear example.

FIG. 13 shows example schematics of a cube with an insulated cut-out, and an extended domain with nonlocal boundary layers for imposing boundary conditions using mechanisms described herein for efficient peridynamic modeling with bounded domains.

In this example, mechanisms described herein and the meshfree (one-point Gaussian integration) spatial discretization were used to solve a 3D PD transient diffusion example with non-periodic local boundary conditions in a domain with a non-trivial geometry. The performance of the two approaches was compared for discretization sizes ranging from 2 million (m-factor of 5.8) to more than 1 billion nodes (m-factor of 46.5), in 3D. Note that in practical problems, there is rarely a reason for using m-factor values larger than 5-10. However, when high accuracy is required, or for problems where nonlocality is relatively large compared to the sample's size, larger m-values (such as the values used for this example) may be needed. The quadratic convergence rate for the spatial discretization discussed in connection with FIGS. 8 and 12 motivates using such large m-values.

The example in this section is a 3D PD diffusion in a 2×2×2 cube with a cutout, having fixed (but different) U values imposed on the top and bottom surfaces (Dirichlet boundary conditions), and zero flux conditions imposed on all four sides of the cube (Neumann boundary conditions). As shown in FIG. 13, the cube has a horizontally aligned disk-shaped insulated cutout/obstacle at the center. The cutout acts as a diffusion barrier with zero flux boundary conditions on all of its surfaces. The mathematical layout for this problem is:

$$\frac{\partial u ( x , t )}{\partial t} = v μ ( {x}^{′} - x ) [ u ( {x}^{′} ) - u ( x ) ] {dx}^{′} \qquad ( 63 )$$

on Ω=[−1,1]³ with the kernel function:

$$μ ( x ) = \{ \begin{matrix}\frac{9}{2 π {δ}^{3} {‖ x ‖}^{2}} ; & ‖ x ‖ \leq δ \\ 0 ; & ‖ x ‖ > δ\end{matrix} , \qquad ( 64 )$$

subjected to the initial condition:

u(x,0)=0, (65)

and the local boundary conditions:

$$\begin{matrix}u ( x , t ) = 1 , x = \{ {x}_{1} , {x}_{2} , 1 \} & ( a ) \\ u ( x , t ) = 0 , x = \{ {x}_{1} , {x}_{2} , - 1 \} & ( b ) \\ ∇ u ( x , t ) \cdot {n}_{1} = 0 , x = \{ 1 , {x}_{2} , {x}_{3} \} and {n}_{1} = \{ 1 , 0 , 0 \} & ( c ) \\ ∇ u ( x , t ) \cdot {n}_{2} = 0 , x = \{ - 1 , {x}_{2} , {x}_{3} \} and {n}_{2} = \{ - 1 , 0 , 0 \} & ( d ) \\ ∇ u ( x , t ) \cdot {n}_{3} = 0 , x = \{ {x}_{1} , 1 , {x}_{3} \} and {n}_{3} = \{ 0 , 1 , 0 \} & ( e ) \\ ∇ u ( x , t ) \cdot {n}_{4} = 0 , x = \{ {x}_{1} , - 1 , {x}_{3} \} and {n}_{4} = \{ 0 , - 1 , 0 \} & ( f ) \\ ∇ u ( x , t ) \cdot {n}_{5} = 0 , x = \{ {x}_{1} , {x}_{2} , 0.1 \} and \sqrt{{x}_{1}^{2} + {x}_{2}^{2}} \leq 0.7 , and {n}_{5} = \{ 0 , 0 , 1 \} & ( g ) \\ ∇ u ( x , t ) \cdot {n}_{6} = 0 , x = \{ {x}_{1} , {x}_{2} , - 0.1 \} and \sqrt{{x}_{1}^{2} + {x}_{2}^{2}} \leq 0.7 , and {n}_{6} = \{ 0 , 0 , - 1 \} & ( h ) \\ ∇ u ( x , t ) \cdot {n}_{7} = 0 , \sqrt{{x}_{1}^{2} + {x}_{2}^{2}} = 0.7 and - 0.1 \leq {x}_{3} \leq 0.1 , and {n}_{7} = \{ \frac{{x}_{1}}{0.7} , \frac{{x}_{2}}{0.7} , 0 \} & ( i )\end{matrix} \qquad ( 66 )$$

EQS. (66)(a) and (b) are the top and bottom Dirichlet boundary conditions, (c) to (f) are zero flux conditions on the cube sides, and (g), (h), and (i) are the zero-flux boundary conditions on the cutout surfaces. For this example, the cutout radius is 0.7, and δ=0.1. Similar to the 1D example in FIG. 7, in order to impose local boundary conditions, the fictitious domain and the formulas described in Appendix A were used. For the external surfaces, the cube was extended by δ in all six directions, and volume constraints were defined on these extensions. For the top and bottom (with conditions of EQS. (66) (g) and (h)) surfaces of the cutout, the extension ends up being the actual cutout volume, of thickness 2δ. FIG. 13 shows the original and the domain extended by the constrained volume: Ω∪Γ.

Since the extended domain (Ω∪Γ) is already a cube, similar to the 1D example in FIG. 7, the periodic box [symbol] can be defined to be Ω∪Γ without any gap (i.e., Λ=Ø).

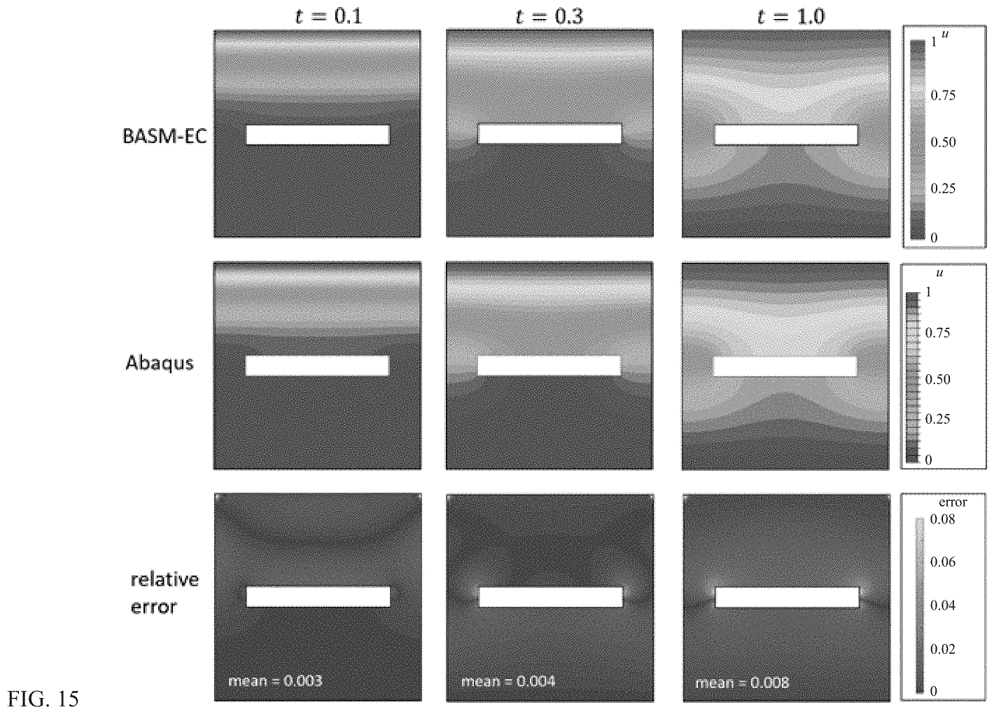

Note that here, the boundary condition in EQ. (66)(i) in the PD model was not enforced, because, given the non-convex characteristics of the geometry, it would overlap regions of fictitious nodes associated with the boundary conditions of EQS. (66) (g), (h), and (i). That would create difficulties in the Fourier space because different points in the domain would be linked to values at the same fictitious node. The cutout thickness of 2δ was chosen to avoid this complication for the domain extension corresponding to the top and bottom surfaces of the cutout. Note that this issue may not appear when using a different method to enforce the local boundary conditions. Here, for simplicity the fictitious nodes method was used. However, as described below in connection with FIG. 15, the error introduced by not enforcing the condition in EQ. (66) (i) is relatively small. Note that this issue is only present when enforcing a local boundary condition in a PD formulation; it does not exist for volume constraints (nonlocal boundary conditions).

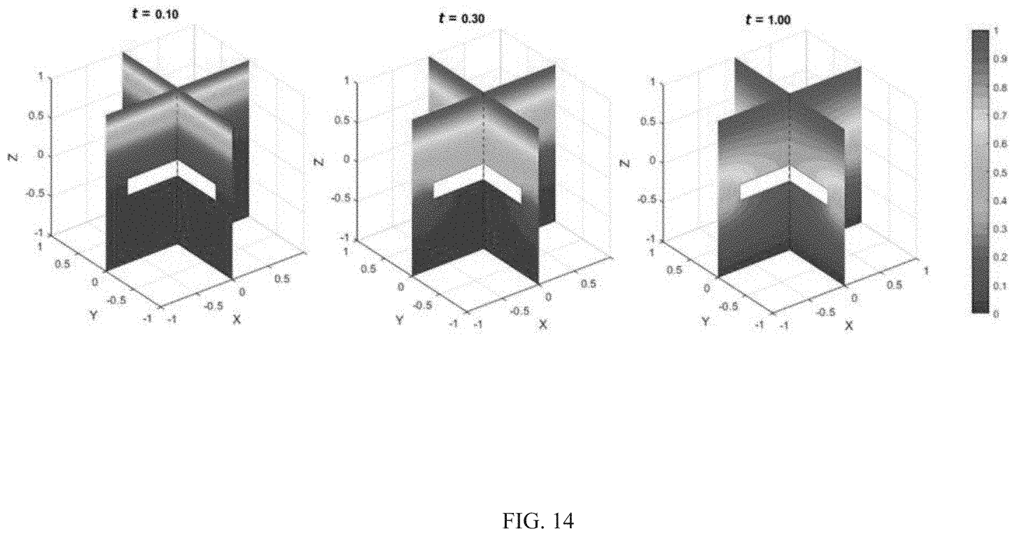

FIG. 14 shows examples of 3D peridynamic diffusion simulation results for a cube with an insulated cutout determined using mechanisms described herein for efficient peridynamic modeling with bounded domains.

For discretization, N₁=N₂=N₃=2⁷ was used first, resulting in m-factor of 5.8 and N=2²¹ as the total number of nodes. The time step used was Δt=5.5×10⁻⁵ to satisfy the stability condition in EQ. (46). A general algorithm for 3D diffusion using mechanisms described herein is described in Appendix C, which is hereby incorporated by reference herein. FIG. 14 shows simulation results in three snapshots at t=0.1, 0.3 and 1. Two perpendicular cross-sectional views of the 3D domain are plotted to make the insulated discontinuity (cutout) visible in the figure.

FIG. 15 shows examples comparing the 3D solution in a cross-section determined using mechanisms described herein for efficient peridynamic modeling with bounded domains, and results generated using conventional techniques.

The temperature/concentration distributions in FIG. 14 shows that the boundary conditions were enforced and the insulated cutout acted as an obstacle to the diffusive transport process. The solution generating using mechanisms described herein for the peridynamic problem was compared with a finite element solution for the corresponding classical boundary value diffusion problem. For the finite element analysis, Abaqus/Standard 6.14-2 (note that this is an implicit solver, compared with the mechanisms described herein which can provide an explicit solver) was used with over 10⁷ DC3D4 type elements and more than 1.8×10⁶ nodes, which is about the same number of degrees of freedom used in the simulation performed in accordance with mechanisms described herein.

As shown in FIG. 15, the nonlocal solution generated using mechanisms described herein is very close to the finite element local solution generated with Abaqus. Although contour levels are set to be the same for two top legends, the contour colors are slightly different since the corresponding colors from Abaqus graphics are slightly different from those in Tecplot used in plotting the results obtained using mechanisms described herein. The bottom row in FIG. 15 shows the absolute relative error distribution, along with its mean value. Relative error here was computed as

$$\frac{\vert {u}_{ij , t}^{FCBM} - {u}_{ij , t}^{Abaqus} \vert}{{‖ {u}_{ij , 0}^{Abaqus} ‖}_{∞}}$$

on the displayed cross-sectional plane.

Note that there is a small discrepancy between the two solutions near the sides of the rectangular obstacle. This is likely due to not enforcing the exact insulated condition on the short lateral sides of the cutout. For the Abaqus solution, all boundary conditions in EQ. (66) were enforced.

In order to demonstrate the superior efficiency that can be achieved using mechanisms described herein, the same example was solved via the conventional meshfree method with one-point Gaussian quadrature, and the computational times for these approaches was compared for various spatial resolutions. Both approaches were implemented in MATLAB R2014b. Simulations were performed on a supercomputer machine in Holland Computing Center of the University of Nebraska-Lincoln, with Intel Xeon E5-2670 2.60 GHz CPUs, up to 512 GB RAM per CPU and a Tesla V100 GPU with 32 GB memory. MATLAB's built-in parallel FFT solvers use multithreading and GPU computations, and this was used in the computational tests. TABLE 1 shows the computational time for the 3D example above using the meshfree with Gaussian quadrature on a single CPU versus using mechanisms described herein on a single CPU, on 8 or 16 CPUs, and on a GPU, for four spatial discretizations. The time steps are identical for all simulations since the stability condition is independent of the discretization size (it only depends on ν, μ and δ, which are the same for all tests). TABLE 1 shows computational time for solving the 3D example up to t=1, using mechanisms described herein (labeled FCBM-EC) and the meshfree method with Gaussian quadrature (GQ).

TABLE 1

| | m-factor | | | | | | | |
|---|---|---|---|---|---|---|---|---|
| | 5.8 | | 11.6 | | 23.3 | | 46.5 | |
| | Number of nodes | | | | | | | |
| | 2²¹ = | | 2²⁴ = | | 2²⁷ = | | 2³⁰ = | |
| | 2,097,152 | | 16,777,216 | | 134,217,728 | | 1,073,741,824 | |
| Meshfree with GQ (1 CPU) | 4.6 | hrs | 12 | days | 2.1 | yrs (!) | 1.4 | centuries (!) |
| FCBM-EC (1 CPU) | 10.7 | min | 1.9 | hrs | 13.7 | hrs | 5.1 | days |
| FCBM-EC (8 CPUs) | 6 | min | 36.6 | min | 4.5 | hrs | 1.4 | days |
| FCBM-EC (16 CPUs) | 2.7 | min | 34.7 | min | 3.9 | hrs | 1.3 | days |

| | | | | | | | |
|---|---|---|---|---|---|---|---|
| FCBM-EC (GPU) | 29 | min | 38.3 | min | 2.1 | hrs | out of memory |

As observed the diffusion example with over 1 billion nodes is solved in a few days using mechanisms described herein, while the same computation is intractable with the meshfree method using one-point Gaussian quadrature.

Note that the computational time for the meshfree method in the cases with m=11.6, 23.3, and 46.5 (N=2²⁴, 2²⁷, and 2³⁰) are estimated based on the assumption that it scales as O(N²). Although the computational time for the meshfree method in the case with m=11.6 (N=2²⁴) would be reasonable (several days), the available memory was not sufficient to perform this test. The simulations performed using mechanisms described herein, in contrast, did not run out of memory even for 1 billion nodes. A reason is likely due to peridynamic meshfree solvers storing family nodes for each node at the beginning to increase efficiency when doing the Gaussian quadrature for the convolution integral. However, there is no need to store family nodes when using mechanisms described herein, as the convolution integrals are replaced by multiplication of the Fourier coefficients, which do not require the family nodes for each node. Note that while the meshfree method can also be performed without storing nodal families, the computational time increases substantially when one needs to re-compute them at every time step.

The results in TABLE 1 show efficiency gains that can be realized using mechanisms described herein versus the meshfree discretization. Notice also the correlation of the gains with the m-factor value. The reason for the larger gains at higher m-values is related to the same point mentioned above: the convolution integrals are replaced by multiplication of the Fourier coefficients, which do not require the family nodes for each node. In other words, a nonlocal computation in the physical space can be transformed into a local computation in Fourier space.

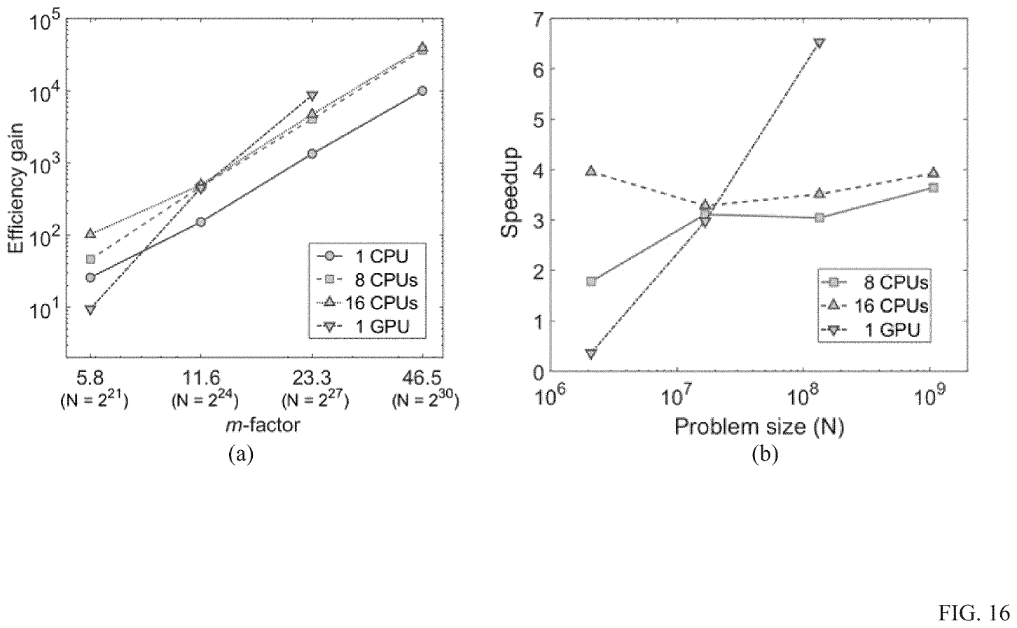

FIG. 16 shows examples of efficiency gains relative to m-factor values for the 3D solution determined using mechanisms described herein for efficient peridynamic modeling with bounded domains over the meshfree technique, and the speedup versus problem size (N) using mechanisms described with parallel fast Fourier transform solvers.

Efficiency gains (computed using EQ. (67)) and speedup (computed using EQ. (68)) are plotted versus the problem size (degrees of freedom) and m-factor values in FIG. 13.

$$Efficiency gain = \frac{computation time for FCBM}{computation time for meshfree method with one CPU} \qquad ( 67 )$$

$$Speedup = \frac{computation time for FCBM with multiple CPUs or GPU}{computation time for FCBM with one CPU} \qquad ( 68 )$$

These computational experiments (via Matlab's parallel FFT functions) show that little was gained from using more than 8 CPUs with multi-threading. They also show that GPU computations using Matlab's intrinsic functions was superior to Matlab's multi-threading for problems with higher spatial resolution (here when the N>2²⁴≅16.8×10⁶), as long as GPU computations are feasible from the memory point of view.

The FE and FCBM-EC simulations shown in FIG. 15 were performed on the same machine using 16 CPUs, and both have a similar number of degrees of freedom (about 2 million). The Abaqus simulation took about 2.5 hours using an implicit solver (note that there is no explicit solver in Abaqus for diffusion problems) to complete while the simulation using mechanisms described herein took only 2.7 minutes. Note that general-purpose software, such as the diffusion solver in Abaqus, is not necessarily optimized for the particular problem setup here. Additionally, an explicit-type solver was used for the PD results, while Abaqus used an implicit solver. This is not necessarily a disadvantage for Abaqus, as an implicit solver implemented for mechanisms described herein can be expected to lead to even more efficient performance. Additionally, the implementation of the mechanisms described herein used to perform the simulation is not necessarily an optimal one, as Matlab's libraries of functions were used.

### Further Examples Having a Variety of Features

Implementation examples are described in the following numbered clauses:

1. A method comprising: receiving a plurality of parameters associated with a non-local model that has a convolutional structure to be used for one or more simulations, wherein the plurality of parameters includes a shape of a domain Ω, a horizon size δ, and one or more boundary constraints; drawing a periodic box T that includes the domain Ω and a boundary layer Γ extending from the domain Ω; imposing the one or more boundary constraints on the boundary layer Γ; performing a simulation of a physical process using the non-local model and convolutional properties of Fourier transforms; and causing a result of the simulation to be presented.

2. The method of clause 1, wherein the non-local model comprises a peridynamic model.

3. The method of any one of clauses 1 or 2, wherein the plurality of parameters includes one or more initial conditions.

4. The method of any one of clauses 1 to 3, wherein performing the simulation comprises: discretizing the non-local model using one or more Fourier transforms, wherein integral operators associated with the model are expressed in terms of convolutions; and solving the discretized non-local model on T.

5. The method of any one of clauses 1 to 4, wherein the non-local model comprises a model of diffusion.

6. The method of clause 5, wherein the model of diffusion is non-linear.

7. The method of any one of clauses 1 to 4, wherein the non-local model comprises a model of deformation and fracture.

8. The method of clause 7, wherein the model of deformation and fracture is non-linear.

9. The method of any one of clauses 1 to 4, wherein the non-local model comprises a model of dissolution damage.

10. The method of any one of clauses 1 to 4, wherein the non-local model comprises a model of corrosion damage.

11. The method of any one of clauses 1 to 10, wherein the domain Ω comprises a three-dimensional (3D) shape.

12. The method of any one of clauses 1 to 11, further comprising, receiving a time step size Δt, wherein the time step size satisfies a constraint.

13. The method of clause 12, wherein the time step size Δt satisfies Δt≤1/vβ, where v is a scalar diffusivity constant associated with the non-local model, and β corresponds to an integral of a kernel function associated with the non-local model over a region H_0 of the domain Ω, H_0 having a size based on the horizon size δ and the dimensionality of the domain Ω.

14. The method of any one of clauses 1 to 13, further comprising, receiving a number of nodes N, in each dimension.

15. The method of any one of clauses 1 to 14, wherein causing the result of the simulation to be presented comprises: causing a visual representation of at least a portion of the non-local model at a particular time step to be presented.

16. The method of any one of clauses 1 to 12 or 14, wherein causing the result of the simulation to be presented comprises: causing a visual state of at least a portion of the non-local model at a particular load step to be presented.

17. The method of any one of clauses 1 to 16, wherein receiving the plurality of parameters associated with the peridynamic model to be simulated, comprises: receiving the plurality of parameters from a remote computing device over a wide area network (WAN).

18. A system for peridynamic modeling, the system comprising: at least one processor that is configured to: receive a plurality of parameters associated with a non-local model that has a convolutional structure to be used for one or more simulations, wherein the plurality of parameters includes a shape of a domain Ω, a horizon size δ, and one or more boundary constraints; draw a periodic box T that includes the domain Ω and a boundary layer Γ extending from the domain Ω; impose the one or more boundary constraints on the boundary layer Γ; perform a simulation of a physical process using the non-local model and convolutional properties of Fourier transforms; and cause a result of the simulation to be presented.

19. A non-transitory computer readable medium containing computer executable instructions that, when executed by a processor, cause the processor to perform a method for peridynamic modeling, the method comprising: receiving a plurality of parameters associated with a non-local model that has a convolutional structure to be used for one or more simulations, including a shape of a domain Ω, a horizon size δ, and one or more boundary constraints; drawing a periodic box T that includes the domain Ω and a boundary layer Γ extending from the domain Ω; imposing the one or more boundary constraints on the boundary layer Γ; performing a simulation of a physical process using the non-local model and convolutional properties of Fourier transforms; and causing a result of the simulation to be presented.

20. A system comprising: at least one hardware processor that is configured to: perform a method of any one of clauses 1 to 17.

21. A non-transitory computer readable medium containing computer executable instructions that, when executed by a processor, cause the processor to perform a method of any one of clauses 1 to 17.

In some embodiments, any suitable computer readable media can be used for storing instructions for performing the functions and/or processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as RAM, Flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, or any suitable media that is fleeting and devoid of any semblance of permanence during transmission, and/or any suitable intangible media.

It should be noted that, as used herein, the term mechanism can encompass hardware, software, firmware, or any suitable combination thereof.

It should be understood that the above-described steps of the processes of FIG. 6 can be executed or performed in any order or sequence not limited to the order and sequence shown and described in the figures. Also, some of the above steps of the processes of FIG. 6 can be executed or performed substantially simultaneously where appropriate or in parallel to reduce latency and processing times.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method comprising:
receiving a plurality of parameters associated with a non-local model that has a convolutional structure to be used for one or more simulations, wherein the plurality of parameters includes a shape of a domain Ω, a horizon size δ, and one or more boundary constraints;
drawing a periodic box [symbol] that includes the domain Ω and a boundary layer Γ extending from the domain Ω;
imposing the one or more boundary constraints on the boundary layer Γ;
performing a simulation of a physical process using the non-local model and convolutional properties of Fourier transforms; and
causing a result of the simulation to be presented.

2. The method of claim 1, wherein the non-local model comprises a peridynamic model.

3. The method of claim 1, wherein the plurality of parameters includes one or more initial conditions.

4. The method of claim 1, wherein performing the simulation comprises:
discretizing the non-local model using one or more Fourier transforms, wherein integral operators associated with the model are expressed in terms of convolutions; and
solving the discretized non-local model on [symbol] .

5. The method of claim 1, wherein the non-local model comprises a model of diffusion.

6. The method of claim 5, wherein the model of diffusion is non-linear.

7. The method of claim 1, wherein the non-local model comprises a model of deformation and fracture.

8. The method of claim 7, wherein the model of deformation and fracture is non-linear.

9. The method of claim 1, wherein the non-local model comprises a model of dissolution damage.

10. The method of claim 1, wherein the non-local model comprises a model of corrosion damage.

11. The method of claim 1, wherein the domain Ω comprises a three-dimensional (3D) shape.

12. The method of claim 1, further comprising, receiving a time step size Δt, wherein the time step size satisfies a constraint.

13. The method of claim 12, wherein the time step size Δt satisfies
$$Δt \leq \frac{1}{v β} ,$$
where ν is a scalar diffusivity constant associated with the non-local model, and β corresponds to an integral of a kernel function associated with the non-local model over a region [symbol] ₀ of the domain Ω, [symbol] ₀ having a size based on the horizon size δ and the dimensionality of the domain Ω.

14. The method of claim 1, further comprising, receiving a number of nodes N, in each dimension.

15. The method of claim 1, wherein causing the result of the simulation to be presented comprises:
causing a visual representation of at least a portion of the non-local model at a particular time step to be presented.

16. The method of claim 1, wherein causing the result of the simulation to be presented comprises:
causing a visual state of at least a portion of the non-local model at a particular load step to be presented.

17. The method of claim 1, wherein receiving the plurality of parameters associated with the peridynamic model to be simulated, comprises:
receiving the plurality of parameters from a remote computing device over a wide area network (WAN).

18. A system for peridynamic modeling, the system comprising:
at least one processor that is configured to:
receive a plurality of parameters associated with a non-local model that has a convolutional structure to be used for one or more simulations, wherein the plurality of parameters includes a shape of a domain Ω, a horizon size δ, and one or more boundary constraints;
draw a periodic box [symbol] that includes the domain Ω and a boundary layer Γ extending from the domain Ω;
impose the one or more boundary constraints on the boundary layer Γ;
perform a simulation of a physical process using the non-local model and convolutional properties of Fourier transforms; and
cause a result of the simulation to be presented.

19. A non-transitory computer readable medium containing computer executable instructions that, when executed by a processor, cause the processor to perform a method for peridynamic modeling, the method comprising:
receiving a plurality of parameters associated with a non-local model that has a convolutional structure to be used for one or more simulations, including a shape of a domain Ω, a horizon size δ, and one or more boundary constraints;
drawing a periodic box [symbol] that includes the domain Ω and a boundary layer Γ extending from the domain Ω;
imposing the one or more boundary constraints on the boundary layer Γ;
performing a simulation of a physical process using the non-local model and convolutional properties of Fourier transforms; and
causing a result of the simulation to be presented.
